(19) United States
(12) Patent Application Publication
(10) Pub. No.: US 2026/0304172 A1
(43) Pub. Date: Oct. 1, 2026

(54) INFERENCE CONFIGURATION FOR ARTIFICIAL INTELLIGENCE/MACHINE LEARNING (AI/ML)-BASED MOBILITY

(71) Applicant: QUALCOMM Incorporated, San Diego, CA (US)

(72) Inventors: Rajeev KUMAR, San Diego, CA (US); Aziz GHOLMIEH, Del Mar, CA (US); Punyaslok PURKAYASTHA, San Diego, CA (US)

(21) Appl. No.: 19/575,879

(22) Filed: Mar. 23, 2026

Related U.S. Application Data
(60) Provisional application No. 63/779,150, filed on Mar. 27, 2025.

(51) Int. Cl. H04W 24/08; H04B 17/318; H04W 24/10; H04W 72/0453

(52) U.S. Cl. CPC H04W 24/08; H04B 17/328; H04W 24/10; H04W 72/0453

(57) ABSTRACT

Certain aspects of the present disclosure provide techniques for wireless communications. An example method includes receiving a radio resource management (RRM) inference configuration, wherein the RRM inference configuration configures: a set of measurement objects, and a reporting configuration; generating one or more RRM predictions based at least in part on one or more measurements according to the set of measurement objects; and transmitting a report including information associated with the one or more RRM predictions, wherein the report is in accordance with the reporting configuration.

### RELATED APPLICATION

The present Application for Patent claims benefit of U.S. Provisional Application No. 63/779,150, filed Mar. 27, 2025, which is hereby expressly incorporated by reference herein in its entirety.

### INTRODUCTION

### Field of the Disclosure

Aspects of the present disclosure relate to wireless communications, and more particularly, to techniques for inference configuration for artificial intelligence or machine learning (AI/ML)-based mobility.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving a radio resource management (RRM) inference configuration, wherein the RRM inference configuration configures: a set of measurement objects, and a reporting configuration; generating one or more RRM predictions based at least in part on one or more measurements according to the set of measurement objects; and transmitting a report including information associated with the one or more RRM predictions, wherein the report is in accordance with the reporting configuration.

Another aspect provides an apparatus configured for wireless communications. The apparatus includes a processing system that includes one or more processors and one or more memories coupled with the one or more processors, the processing system configured to cause a UE to: receive an RRM inference configuration, wherein the RRM inference configuration configures: a set of measurement objects, and a reporting configuration; generate one or more RRM predictions based at least in part on one or more measurements according to the set of measurement objects; and transmit a report including information associated with the one or more RRM predictions, wherein the report is in accordance with the reporting configuration.

Another aspect provides one or more apparatuses configured for wireless communications. The one or more apparatuses include: means for receiving an RRM inference configuration, wherein the RRM inference configuration configures: a set of measurement objects, and a reporting configuration; means for generating one or more RRM predictions based at least in part on one or more measurements according to the set of measurement objects; and means for transmitting a report including information associated with the one or more RRM predictions, wherein the report is in accordance with the reporting configuration.

Another aspect provides one or more non-transitory computer-readable media. The one or more non-transitory computer-readable media include executable instructions that, when executed by one or more processors of one or more apparatuses, cause the one or more apparatuses to receive an RRM inference configuration, wherein the RRM inference configuration configures: a set of measurement objects, and a reporting configuration; generate one or more RRM predictions based at least in part on one or more measurements according to the set of measurement objects; and transmit a report including information associated with the one or more RRM predictions, wherein the report is in accordance with the reporting configuration.

In some examples of the methods, apparatuses, and non-transitory computer-readable medium described herein, the set of measurement objects comprises an ARFCN, wherein generating the one or more RRM predictions comprises: performing the one or more measurements on a first subset of cells or beams in the ARFCN, and generating an intra-frequency RRM prediction for a second subset of cells or beams in the ARFCN based at least in part on a result of the one or more measurements on the first subset of cells or beams.

Some examples of the methods, apparatuses, and non-transitory computer-readable medium described herein may further include operations, features, means, or instructions for receiving an indication of a minimum quantity of cells or beams to be measured in association with the intra-frequency RRM prediction, wherein a quantity of cells or beams in the first subset of cells or beams is in accordance with the indication.

In some examples of the methods, apparatuses, and non-transitory computer-readable medium described herein, the set of measurement objects comprises a first set of cells or beams in a frequency band and a second set of cells or beams in the frequency band, wherein generating the one or more RRM predictions comprises: performing the one or more measurements on the first set of cells or beams, and generating an intra-frequency RRM prediction for the second set of cells or beams based at least in part on a result of the one or more measurements on the first set of cells or beams.

In some examples of the methods, apparatuses, and non-transitory computer-readable medium described herein, the set of measurement objects comprises a first ARFCN list and a second ARFCN list, wherein generating the one or more RRM predictions comprises: performing the one or more measurements on a set of cells or beams from the first ARFCN list, and generating an inter-frequency RRM prediction for a set of cells or beams from the second ARFCN list based at least in part on a result of the one or more measurements on the set of cells or beams from the first ARFCN list.

Some examples of the methods, apparatuses, and non-transitory computer-readable medium described herein may further include operations, features, means, or instructions for receiving a first indication of a minimum quantity of cells or beams to be measured, receiving a second indication of at least one of: a minimum quantity of cells or beams to be predicted, or a maximum quantity of cells or beams to be predicted, wherein a quantity of cells or beams in the set of cells or beams from the first ARFCN list is in accordance with the first indication and a quantity of cells or beams in the set of cells or beams from the second ARFCN list is in accordance with the second indication.

In some examples of the methods, apparatuses, and non-transitory computer-readable medium described herein, the set of measurement objects comprises a set of cells or beams from a first ARFCN list and a set of cells or beams from a second ARFCN list, wherein generating the one or more RRM predictions comprises: performing the one or more measurements on the set of cells or beams from the first ARFCN list, and generating an inter-frequency RRM prediction for the set of cells or beams from the second ARFCN list based at least in part on a result of the one or more measurements on the set of cells or beams from the first ARFCN list.

In some examples of the methods, apparatuses, and non-transitory computer-readable medium described herein, the one or more RRM predictions include at least one spatial prediction.

In some examples of the methods, apparatuses, and non-transitory computer-readable medium described herein, the one or more RRM predictions include at least one temporal prediction associated with a plurality of time instances or a time window.

Some examples of the methods, apparatuses, and non-transitory computer-readable medium described herein may further include operations, features, means, or instructions for determining that a value of an RRM prediction, of the one or more RRM predictions, satisfies a threshold, wherein transmitting the report comprises transmitting the report including the value of the RRM prediction based at least in part on the value of the RRM prediction satisfying the threshold.

Some examples of the methods, apparatuses, and non-transitory computer-readable medium described herein may further include operations, features, means, or instructions for determining that a value of a result of a measurement associated with a temporal prediction, of the one or more RRM predictions, is within a configured range, wherein transmitting the report comprises dropping the value from the report based at least in part on the value being within the configured range.

In some examples of the methods, apparatuses, and non-transitory computer-readable medium described herein, the RRM inference configuration configures the set of measurement objects using a single measurement object identifier associated with a single measurement object for measurement and prediction.

In some examples of the methods, apparatuses, and non-transitory computer-readable medium described herein, the RRM inference configuration configures the set of measurement objects using a first measurement object identifier associated with a first measurement object for measurement, a second measurement object identifier associated with a second measurement object for prediction, and a single measurement identifier associated with both the first measurement object for measurement and the second measurement object for prediction.

In some examples of the methods, apparatuses, and non-transitory computer-readable medium described herein, the RRM inference configuration configures the set of measurement objects using a first measurement object identifier associated with a first measurement object for measurement, a second measurement object identifier associated with a second measurement object for prediction, a first measurement identifier associated with the first measurement object for measurement, and a second measurement identifier associated with the second measurement object for prediction.

In some examples of the methods, apparatuses, and non-transitory computer-readable medium described herein, the information associated with the one or more RRM predictions includes one or more actual prediction values.

In some examples of the methods, apparatuses, and non-transitory computer-readable medium described herein, the information associated with the one or more RRM predictions includes one or more differential values.

In some examples of the methods, apparatuses, and non-transitory computer-readable medium described herein, a differential value of the one or more differential values is with respect to a single reference value, wherein the single reference value is a highest value among values of measurements of all measurement types.

In some examples of the methods, apparatuses, and non-transitory computer-readable medium described herein, a differential value of the one or more differential values is with respect to a particular reference value from a set of reference values, wherein the particular reference value is a highest value among values of measurements of a measurement type that matches a measurement type associated with the differential value.

In some examples of the methods, apparatuses, and non-transitory computer-readable medium described herein, the one or more RRM predictions include a temporal prediction, wherein a reference time associated with the temporal prediction is based on a last measurement occasion associated with the one or more measurements based at least in part on which the temporal prediction is generated.

In some examples of the methods, apparatuses, and non-transitory computer-readable medium described herein, the one or more RRM predictions include at least one intra-frequency RRM prediction or at least one inter-frequency RRM prediction, wherein the information associated with the one or more RRM predictions includes one or more prediction values.

In some examples of the methods, apparatuses, and non-transitory computer-readable medium described herein, the one or more prediction values include at least one of: a predicted RSRP, a predicted RSRQ, a predicted SINR, or a predicted beam.

In some examples of the methods, apparatuses, and non-transitory computer-readable medium described herein, the one or more RRM predictions include at least one intra-frequency RRM prediction or at least one inter-frequency RRM prediction, wherein the information associated with the one or more RRM predictions includes one or more prediction values and one or more measurement values associated with the one or more prediction values.

In some examples of the methods, apparatuses, and non-transitory computer-readable medium described herein, the one or more RRM predictions include at least one temporal prediction, wherein the information associated with the one or more RRM predictions includes a predicted RSRP over a plurality of time instances or over a time window.

One aspect provides a method for wireless communications by a network entity. The method includes transmitting an RRM inference configuration, wherein the RRM inference configuration configures: a set of measurement objects, and a reporting configuration; and receiving a report including information associated with the one or more RRM predictions based at least in part on one or more measurements according to the set of measurement objects, wherein the report is in accordance with the reporting configuration.

Another aspect provides an apparatus configured for wireless communications. The apparatus includes a processing system that includes one or more processors and one or more memories coupled with the one or more processors, the processing system configured to cause a network entity to: transmit an RRM inference configuration, wherein the RRM inference configuration configures: a set of measurement objects, and a reporting configuration; and receive a report including information associated with the one or more RRM predictions based at least in part on one or more measurements according to the set of measurement objects, wherein the report is in accordance with the reporting configuration.

Another aspect provides one or more apparatuses configured for wireless communications. The one or more apparatuses include means for transmitting an RRM inference configuration, wherein the RRM inference configuration configures: a set of measurement objects, and a reporting configuration; and means for receiving a report including information associated with the one or more RRM predictions based at least in part on one or more measurements according to the set of measurement objects, wherein the report is in accordance with the reporting configuration.

Another aspect provides one or more non-transitory computer-readable media. The one or more non-transitory computer-readable media include executable instructions that, when executed by one or more processors of one or more apparatuses, cause the one or more apparatuses to transmit an RRM inference configuration, wherein the RRM inference configuration configures: a set of measurement objects, and a reporting configuration; and receive a report including information associated with the one or more RRM predictions based at least in part on one or more measurements according to the set of measurement objects, wherein the report is in accordance with the reporting configuration.

In some examples of the methods, apparatuses, and non-transitory computer-readable medium described herein, the set of measurement objects comprises an ARFCN.

Some examples of the methods, apparatuses, and non-transitory computer-readable medium described herein may further include operations, features, means, or instructions for transmitting an indication of a minimum quantity of cells or beams of the ARFCN to be measured in association with an intra-frequency RRM prediction.

In some examples of the methods, apparatuses, and non-transitory computer-readable medium described herein, the set of measurement objects comprises a first set of cells or beams in a frequency band and a second set of cells or beams in the frequency band.

In some examples of the methods, apparatuses, and non-transitory computer-readable medium described herein, the set of measurement objects comprises a first ARFCN list and a second ARFCN list.

Some examples of the methods, apparatuses, and non-transitory computer-readable medium described herein may further include operations, features, means, or instructions for transmitting a first indication of a minimum quantity of cells or beams of the first ARFCN list to be measured, transmitting a second indication of at least one of: a minimum quantity of cells or beams of the second ARFCN list to be predicted, or a maximum quantity of cells or beams of the second ARFCN list to be predicted.

In some examples of the methods, apparatuses, and non-transitory computer-readable medium described herein, the set of measurement objects comprises a set of cells or beams from a first ARFCN list and a set of cells or beams from a second ARFCN list.

In some examples of the methods, apparatuses, and non-transitory computer-readable medium described herein, the one or more RRM predictions include at least one spatial prediction.

In some examples of the methods, apparatuses, and non-transitory computer-readable medium described herein, the one or more RRM predictions include at least one temporal prediction associated with a plurality of time instances or a time window.

In some examples of the methods, apparatuses, and non-transitory computer-readable medium described herein, the report includes a value of an RRM prediction, of the one or more RRM predictions, based at least in part on the value of the RRM prediction satisfying a threshold.

In some examples of the methods, apparatuses, and non-transitory computer-readable medium described herein, the RRM inference configuration configures the set of measurement objects using a single measurement object identifier associated with a single measurement object for measurement and prediction.

In some examples of the methods, apparatuses, and non-transitory computer-readable medium described herein, the RRM inference configuration configures the set of measurement objects using a first measurement object identifier associated with a first measurement object for measurement, a second measurement object identifier associated with a second measurement object for prediction, and a single measurement identifier associated with both the first measurement object for measurement and the second measurement object for prediction.

In some examples of the methods, apparatuses, and non-transitory computer-readable medium described herein, the RRM inference configuration configures the set of measurement objects using a first measurement object identifier associated with a first measurement object for measurement, a second measurement object identifier associated with a second measurement object for prediction, a first measurement identifier associated with the first measurement object for measurement, and a second measurement identifier associated with the second measurement object for prediction.

In some examples of the methods, apparatuses, and non-transitory computer-readable medium described herein, the information associated with the one or more RRM predictions includes one or more actual prediction values.

In some examples of the methods, apparatuses, and non-transitory computer-readable medium described herein, the information associated with the one or more RRM predictions includes one or more differential values.

In some examples of the methods, apparatuses, and non-transitory computer-readable medium described herein, a differential value of the one or more differential values is with respect to a single reference value, wherein the single reference value is a highest value among values of measurements of all measurement types.

In some examples of the methods, apparatuses, and non-transitory computer-readable medium described herein, a differential value of the one or more differential values is with respect to a particular reference value from a set of reference values, wherein the particular reference value is a highest value among values of measurements of a measurement type that matches a measurement type associated with the differential value.

In some examples of the methods, apparatuses, and non-transitory computer-readable medium described herein, the one or more RRM predictions include a temporal prediction, wherein a reference time associated with the temporal prediction is based on a last measurement occasion associated with the one or more measurements based at least in part on which the temporal prediction is generated.

In some examples of the methods, apparatuses, and non-transitory computer-readable medium described herein, the one or more RRM predictions include at least one intra-frequency RRM prediction or at least one inter-frequency RRM prediction, wherein the information associated with the one or more RRM predictions includes one or more prediction values.

In some examples of the methods, apparatuses, and non-transitory computer-readable medium described herein, the one or more prediction values include at least one of: a predicted RSRP, a predicted RSRQ, a predicted SINR, or a predicted beam.

In some examples of the methods, apparatuses, and non-transitory computer-readable medium described herein, the one or more RRM predictions include at least one intra-frequency RRM prediction or at least one inter-frequency RRM prediction, wherein the information associated with the one or more RRM predictions includes one or more prediction values and one or more measurement values associated with the one or more prediction values.

In some examples of the methods, apparatuses, and non-transitory computer-readable medium described herein, the one or more RRM predictions include at least one temporal prediction, wherein the information associated with the one or more RRM predictions includes a predicted RSRP over a plurality of time instances or over a time window.

One aspect provides a method for wireless communications by a UE. The method includes receiving a measurement event inference configuration, wherein the measurement event inference configuration configures: a set of measurement objects, a prediction reporting configuration associated with reporting measurement event predictions, and a measurement reporting configuration associated with reporting measurements; generating one or more measurement event predictions based at least in part on one or more measurements according to the set of measurement objects; and transmitting a prediction report including information associated with the one or more measurement event predictions, wherein the prediction report is in accordance with the prediction reporting configuration.

Another aspect provides an apparatus configured for wireless communications. The apparatus includes a processing system that includes one or more processors and one or more memories coupled with the one or more processors, the processing system configured to cause a UE to: receive a measurement event inference configuration, wherein the measurement event inference configuration configures: a set of measurement objects, a prediction reporting configuration associated with reporting measurement event predictions, and a measurement reporting configuration associated with reporting measurements; generate one or more measurement event predictions based at least in part on one or more measurements according to the set of measurement objects; and transmit a prediction report including information associated with the one or more measurement event predictions, wherein the prediction report is in accordance with the prediction reporting configuration.

Another aspect provides one or more apparatuses configured for wireless communications. The one or more apparatuses include means for receiving a measurement event inference configuration, wherein the measurement event inference configuration configures: a set of measurement objects, a prediction reporting configuration associated with reporting measurement event predictions, and a measurement reporting configuration associated with reporting measurements; means for generating one or more measurement event predictions based at least in part on one or more measurements according to the set of measurement objects; and means for transmitting a prediction report including information associated with the one or more measurement event predictions, wherein the prediction report is in accordance with the prediction reporting configuration.

Another aspect provides one or more non-transitory computer-readable media. The one or more non-transitory computer-readable media include executable instructions that, when executed by one or more processors of one or more apparatuses, cause the one or more apparatuses to: receive a measurement event inference configuration, wherein the measurement event inference configuration configures: a set of measurement objects, a prediction reporting configuration associated with reporting measurement event predictions, and a measurement reporting configuration associated with reporting measurements; generate one or more measurement event predictions based at least in part on one or more measurements according to the set of measurement objects; and transmit a prediction report including information associated with the one or more measurement event predictions, wherein the prediction report is in accordance with the prediction reporting configuration.

Some examples of the methods, apparatuses, and non-transitory computer-readable medium described herein may further include operations, features, means, or instructions for transmitting a measurement report including information associated with the one or more measurements based at least in part on which the one or more measurement event predictions are generated, wherein the measurement report is in accordance with the measurement reporting configuration.

In some examples of the methods, apparatuses, and non-transitory computer-readable medium described herein, the set of measurement objects comprises an ARFCN, wherein generating the one or more measurement event predictions comprises: performing the one or more measurements on a first subset of cells or beams in the ARFCN, and generating an intra-frequency measurement event prediction for a second subset of cells or beams in the ARFCN based at least in part on a result of the one or more measurements on the first subset of cells or beams.

Some examples of the methods, apparatuses, and non-transitory computer-readable medium described herein may further include operations, features, means, or instructions for receiving an indication of a minimum quantity of cells or beams to be measured in association with the intra-frequency measurement event prediction, wherein a quantity of cells or beams in the first subset of cells or beams is in accordance with the indication.

In some examples of the methods, apparatuses, and non-transitory computer-readable medium described herein, the set of measurement objects comprises a first set of cells or beams in a frequency band and a second set of cells or beams in the frequency band, wherein generating the one or more measurement event predictions comprises: performing the one or more measurements on the first set of cells or beams, and generating an intra-frequency measurement event prediction for the second set of cells or beams based at least in part on a result of the one or more measurements on the first set of cells or beams.

In some examples of the methods, apparatuses, and non-transitory computer-readable medium described herein, the set of measurement objects comprises a first ARFCN list and a second ARFCN list, wherein generating the one or more measurement event predictions comprises: performing the one or more measurements on a set of cells or beams from the first ARFCN list, and generating an inter-frequency measurement event prediction for a set of cells or beams from the second ARFCN list based at least in part on a result of the one or more measurements on the set of cells or beams from the first ARFCN list.

Some examples of the methods, apparatuses, and non-transitory computer-readable medium described herein may further include operations, features, means, or instructions for receiving a first indication of a minimum quantity of cells or beams to be measured, receiving a second indication of at least one of: a minimum quantity of cells or beams to be predicted, or a maximum quantity of cells or beams to be predicted, wherein a first quantity of cells or beams in the set of cells or beams from the first ARFCN list is in accordance with the first indication and a second quantity of cells or beams in the set of cells or beams from the second ARFCN list is in accordance with the second indication.

In some examples of the methods, apparatuses, and non-transitory computer-readable medium described herein, the set of measurement objects comprises a set of cells or beams from a first ARFCN list and a set of cells or beams from a second ARFCN list, wherein generating the one or more measurement event predictions comprises: performing the one or more measurements on the set of cells or beams from the first ARFCN list, and generating an inter-frequency measurement event prediction for the set of cells or beams from the second ARFCN list based at least in part on a result of the one or more measurements on the set of cells or beams from the first ARFCN list.

In some examples of the methods, apparatuses, and non-transitory computer-readable medium described herein, the one or more measurement event predictions include at least one temporal prediction associated with a plurality of time instances or a time window.

Some examples of the methods, apparatuses, and non-transitory computer-readable medium described herein may further include operations, features, means, or instructions for detecting a trigger event indicated in the prediction reporting configuration, wherein transmitting the report comprises transmitting the report based at least in part on the detection of the trigger event.

In some examples of the methods, apparatuses, and non-transitory computer-readable medium described herein, the prediction reporting configuration indicates a report quantity for the one or more measurement event predictions, wherein the report quantity indicates a single measurement event prediction result or a set of measurement event prediction results associated with a time window.

In some examples of the methods, apparatuses, and non-transitory computer-readable medium described herein, the prediction reporting configuration and the measurement reporting configuration are included in a single reporting configuration.

In some examples of the methods, apparatuses, and non-transitory computer-readable medium described herein, the single reporting configuration indicates one or more trigger events, wherein the one or more trigger events include at least one of a UE prediction trigger or a network measurement trigger.

In some examples of the methods, apparatuses, and non-transitory computer-readable medium described herein, the single reporting configuration indicates reporting contents associated with reporting the one or more measurement event predictions or the one or more measurements.

In some examples of the methods, apparatuses, and non-transitory computer-readable medium described herein, the prediction reporting configuration and the measurement reporting configuration are separate reporting configurations.

In some examples of the methods, apparatuses, and non-transitory computer-readable medium described herein, the measurement event inference configuration further includes mapping information that links the prediction reporting configuration and the measurement reporting configuration.

One aspect provides a method for wireless communications by a network entity. The method includes transmitting a measurement event inference configuration, wherein the measurement event inference configuration configures: a set of measurement objects, a prediction reporting configuration associated with reporting measurement event predictions, and a measurement reporting configuration associated with reporting measurements; and receiving a prediction report including information associated with one or more measurement event predictions that are based at least in part on one or more measurements according to the set of measurement objects, wherein the prediction report is in accordance with the prediction reporting configuration.

Another aspect provides an apparatus configured for wireless communications. A processing system includes one or more processors and one or more memories coupled with the one or more processors, the processing system configured to cause a network entity to: transmit a measurement event inference configuration, wherein the measurement event inference configuration configures: a set of measurement objects, a prediction reporting configuration associated with reporting measurement event predictions, and a measurement reporting configuration associated with reporting measurements; and receive a prediction report including information associated with one or more measurement event predictions that are based at least in part on one or more measurements according to the set of measurement objects, wherein the prediction report is in accordance with the prediction reporting configuration.

Another aspect provides one or more apparatuses configured for wireless communications. The one or more apparatuses include means for transmitting a measurement event inference configuration, wherein the measurement event inference configuration configures: a set of measurement objects, a prediction reporting configuration associated with reporting measurement event predictions, and a measurement reporting configuration associated with reporting measurements; and means for receiving a prediction report including information associated with one or more measurement event predictions that are based at least in part on one or more measurements according to the set of measurement objects, wherein the prediction report is in accordance with the prediction reporting configuration.

Another aspect provides one or more non-transitory computer-readable media. The one or more non-transitory computer-readable media include executable instructions that, when executed by one or more processors of one or more apparatuses, cause the one or more apparatuses to: transmit a measurement event inference configuration, wherein the measurement event inference configuration configures: a set of measurement objects, a prediction reporting configuration associated with reporting measurement event predictions, and a measurement reporting configuration associated with reporting measurements; and receive a prediction report including information associated with one or more measurement event predictions that are based at least in part on one or more measurements according to the set of measurement objects, wherein the prediction report is in accordance with the prediction reporting configuration.

Some examples of the methods, apparatuses, and non-transitory computer-readable medium described herein may further include operations, features, means, or instructions for receiving a measurement report including information associated with the one or more measurements based at least in part on which the one or more measurement event predictions are generated, wherein the measurement report is in accordance with the measurement reporting configuration.

In some examples of the methods, apparatuses, and non-transitory computer-readable medium described herein, the set of measurement objects comprises an ARFCN.

Some examples of the methods, apparatuses, and non-transitory computer-readable medium described herein may further include operations, features, means, or instructions for transmitting an indication of a minimum quantity of cells or beams of the ARFCN to be measured in association with an intra-frequency measurement event prediction.

In some examples of the methods, apparatuses, and non-transitory computer-readable medium described herein, the set of measurement objects comprises a first set of cells or beams in a frequency band and a second set of cells or beams in the frequency band.

In some examples of the methods, apparatuses, and non-transitory computer-readable medium described herein, the set of measurement objects comprises a first ARFCN list and a second ARFCN list.

Some examples of the methods, apparatuses, and non-transitory computer-readable medium described herein may further include operations, features, means, or instructions for transmitting a first indication of a minimum quantity of cells or beams of the first ARFCN list to be measured, receiving a second indication of at least one of: a minimum quantity of cells or beams of the second ARFCN list to be predicted, or a maximum quantity of cells or beams of the second ARFCN list to be predicted.

In some examples of the methods, apparatuses, and non-transitory computer-readable medium described herein, the set of measurement objects comprises a set of cells or beams from a first ARFCN list and a set of cells or beams from a second ARFCN list.

In some examples of the methods, apparatuses, and non-transitory computer-readable medium described herein, the one or more measurement event predictions include at least one temporal prediction associated with a plurality of time instances or a time window.

In some examples of the methods, apparatuses, and non-transitory computer-readable medium described herein, the prediction reporting configuration indicates a report quantity for the one or more measurement event predictions, wherein the report quantity indicates a single measurement event prediction result or a set of measurement event prediction results associated with a time window.

In some examples of the methods, apparatuses, and non-transitory computer-readable medium described herein, the prediction reporting configuration and the measurement reporting configuration are included in a single reporting configuration.

In some examples of the methods, apparatuses, and non-transitory computer-readable medium described herein, the single reporting configuration indicates one or more trigger events, wherein the one or more trigger events include at least one of a UE prediction trigger or a network measurement trigger.

In some examples of the methods, apparatuses, and non-transitory computer-readable medium described herein, the single reporting configuration indicates reporting contents associated with reporting the one or more measurement event predictions or the one or more measurements.

In some examples of the methods, apparatuses, and non-transitory computer-readable medium described herein, the prediction reporting configuration and the measurement reporting configuration are separate reporting configurations.

In some examples of the methods, apparatuses, and non-transitory computer-readable medium described herein, the measurement event inference configuration further includes mapping information that links the prediction reporting configuration and the measurement reporting configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram illustrating examples of beam management procedures.

FIG. 6 depicts an example artificial intelligence (AI) architecture.

FIG. 7 is a diagram illustrating example beam prediction by a UE.

FIG. 8 depicts a process flow for communications in a network between a UE and a network entity.

FIG. 9 depicts a process flow for communications in a network between a UE and a network entity.

FIGS. 10-11 depict examples associated with an inference configuration for measurement event prediction and reporting as described herein.

FIG. 12 depicts a method for wireless communications.

FIG. 13 depicts aspects of an example communications device.

FIG. 14 depicts another method for wireless communications.

FIG. 15 depicts aspects of an example communications device.

FIG. 16 depicts a method for wireless communications.

FIG. 17 depicts aspects of an example communications device.

FIG. 18 depicts another method for wireless communications.

FIG. 19 depicts aspects of an example communications device.

### DETAILED DESCRIPTION

Aspects of the present disclosure provide apparatuses, methods, processing systems, and computer-readable mediums for inference configuration for AI/ML-based mobility.

A wireless communications system may support AI/ML-based mobility. AI/ML-based mobility refers to the use of AI and/or ML to improve a manner in which mobile devices (e.g., UEs) move across and connect to a wireless network. AI/ML-based mobility can provide, for example, predictive mobility management, handover optimization, or load balancing, among other examples. AI-ML-based mobility may provide improved performance of the wireless communications system, such as smooth connectivity, lower latency, or improved quality of service.

In some scenarios, AI/ML-based mobility may use measurement prediction at a cell level (herein referred to as radio resource management (RRM) prediction). In general, RRM prediction can be viewed as an extension of beam-level measurement prediction (e.g., such that predictions are generated with respect to a serving cell of the UE or candidate cell(s) of the UE, in addition to or rather than beams of the UE). In some examples, an AI/ML model used for RRM prediction may be a UE-side model (e.g., such that the UE generates a prediction) or may be a network-side model (e.g., such that a network entity generates a prediction associated with the UE). Further, in some scenarios, AI/ML-based mobility may use measurement event prediction, such as a prediction associated with measurement event A3 (e.g., when a characteristic of a neighbor cell becomes better than a characteristic of a serving cell signal by at least an offset amount), a prediction associated with measurement A5 (e.g., when a characteristic of a current serving cell becomes less than a first threshold while a characteristic of a neighbor cell becomes greater than a second threshold), or the like.

Of note, with respect to inference configuration for AI/ML-based beam management, a UE may be configured to report a prediction result for one time instance for BM-case 1 (e.g., where a model is used to predict spatial domain (SD) downlink beams for a set of predicted beams—referred to as Set A—based on measurement results of a set of measurement beams—referred to as Set B) or for N time instances for BM-case 2 (e.g., where a model is used to predict time domain (TD) downlink beams for Set A based on the historic measurement results of Set B beams). With respect to quantization of a reported reference signal received power (RSRP), the UE is configured to use a largest RSRP value based on the prediction of all time instances as a reference RSRP, and report differential RSRPs relative to the reference RSRP. The time instance information of the beam with the largest RSRP is also indicated in the report. Further, a time gap between two consecutive future time instances and number of instances is configured by radio resource control (RRC) signaling. A reference time of an earliest time instance for the predicted results is based on a most recent occasion of a resource in Set B. Inference results for a UE-side model for BM-Case 1 and BM-Case 2 are to include predicted RSRP(s) that are based on an AI/ML output. Further, for both BM-Case 1 and BM-Case 2, for a UE-side model for inference, when Set A and Set B are configured within a channel state information (CSI) report configuration, CSI resource configuration identifiers are configured for Set A and Set B separately. No such inference configuration is defined with respect to RRM prediction and reporting or measurement event prediction and reporting.

Technical problems for enabling AI/ML-based mobility may include, for example, configuration associated with RRM prediction performance and reporting, and measurement event prediction performance and reporting. That is, a UE must be configured with respect to prediction and reporting in order to enable AI/ML based mobility. For example, with respect to RRM prediction, contents of an inference configuration, a manner in which measurement resources and prediction resources are configured, and a manner in which reporting is to be performed need to be defined. Similarly, with respect to measurement event prediction, contents of an inference configuration, a manner in which an inference configuration is provided, and a manner in which reporting is performed need to be defined. Absent such configurations, RRM prediction and measurement event prediction in support of AI/ML-based mobility are not possible.

Aspects described herein may overcome the aforementioned technical problem(s), for example, by providing inference configuration for AI/ML-based mobility. In some aspects, a UE may receive, from a network entity, an RRM inference configuration. The RRM inference configuration may configure a set of measurement objects associated with generating RRM predictions, and a reporting configuration. The UE may generate one or more RRM predictions based at least in part on one or more measurements according to the set of measurement objects, and may transmit, to the network entity, a report including information associated with the one or more RRM predictions and in accordance with the reporting configuration.

Further, in some aspects, a UE may receive, from a network entity, a measurement event inference configuration. The measurement event inference configuration may configure a set of measurement objects associated with generating measurement event predictions or measurements, a prediction reporting configuration associated with reporting measurement event predictions, and a measurement reporting configuration associated with reporting measurements. The UE may generate one or more measurement event predictions based at least in part on one or more measurements according to the set of measurement objects, and may transmit a prediction report including information associated with the one or more measurement event predictions and in accordance with the prediction reporting configuration.

Certain techniques for inference configuration for AI/ML-based mobility described herein may provide various beneficial technical effects and/or advantages. The techniques for inference configuration for AI/ML-based mobility may enable improved wireless communications performance, such as smooth connectivity, lower latency, or improved quality of service that can be achieved through AI/ML-based mobility. The improved wireless communication performance may be attributable to the techniques and apparatuses described herein, for example, due to the provisioning of inference configurations for RRM prediction performance and reporting and measurement event prediction performance and reporting described herein that enable AI/ML based mobility.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

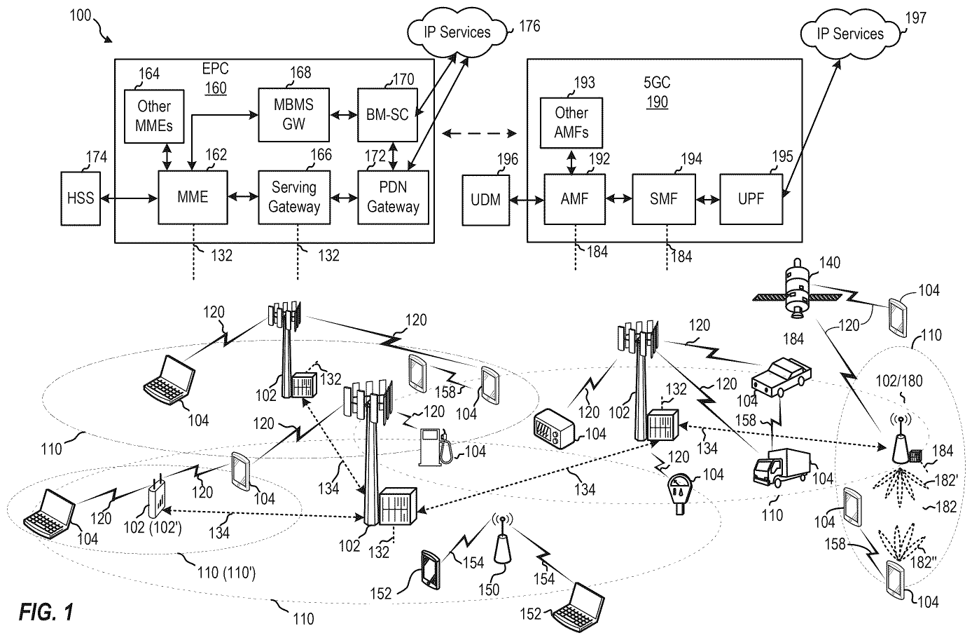

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

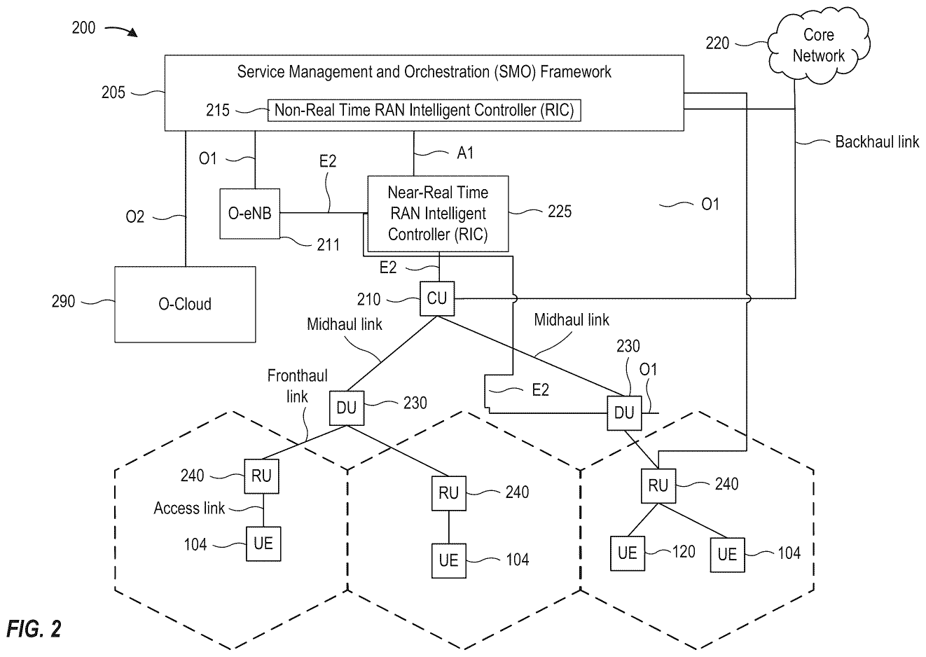

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

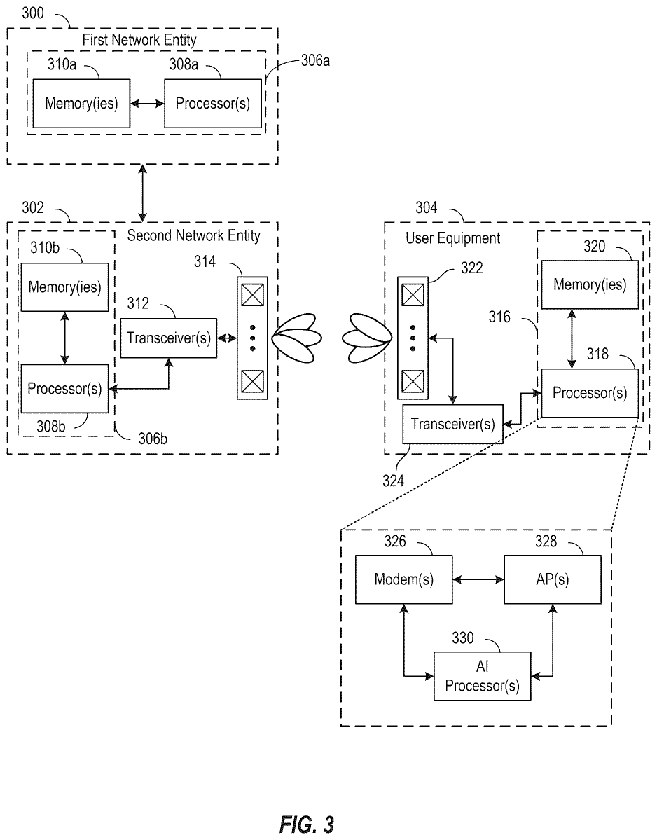

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

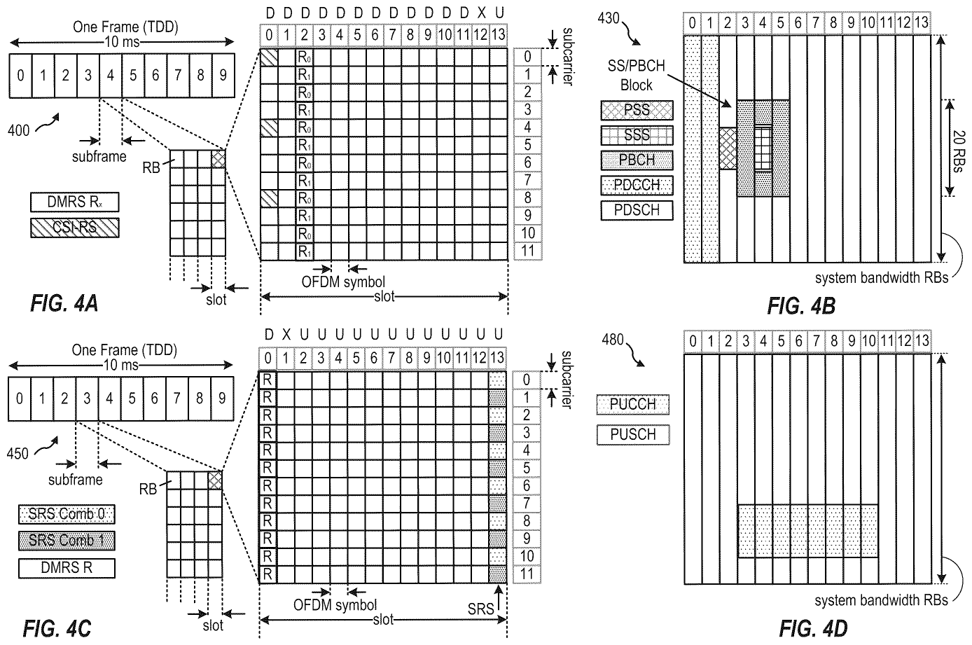

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Beam Management

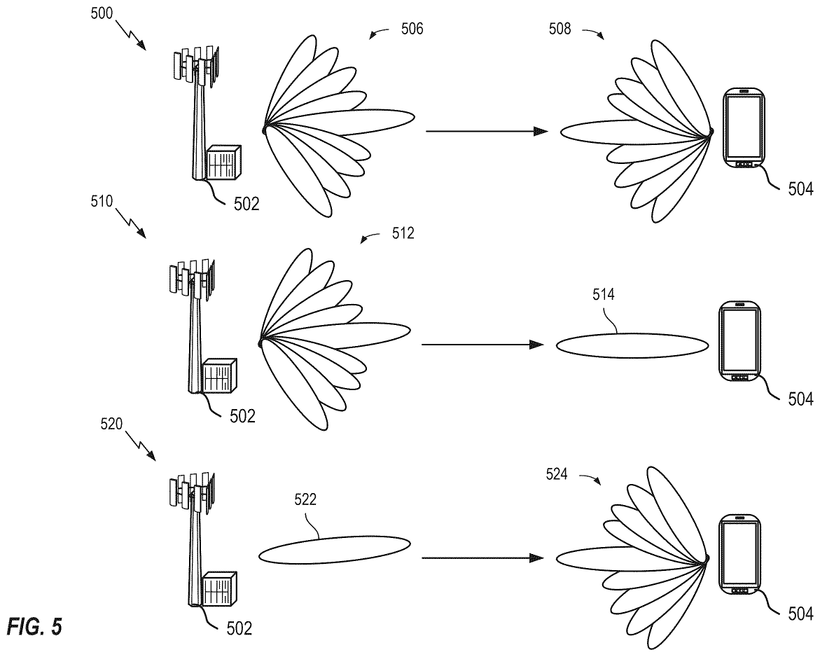

FIG. 5 is a diagram illustrating examples 500, 510, and 520 of beam management procedures. As shown in FIG. 5, examples 500, 510, and 520 include a UE 504 (e.g., UE 104/304) in communication with a BS 502 (e.g., BS 102, network entity 300/302) in a wireless network (e.g., wireless communications network 100 in FIG. 1). However, the devices shown in FIG. 5 are provided as examples, and the wireless network may support communication and beam management between other devices (e.g., between a UE 504 and a network entity, a UE 504 and a transmission reception point (TRP), between a mobile termination node and a control node, between an integrated access and backhaul (IAB) child node and an IAB parent node, between a scheduled node and a scheduling node, and/or the like). In some aspects, the UE 504 and the BS 502 are in a connected state (e.g., RRC connected state and/or the like).

BS 502 and UE 504 may communicate to perform beam management using reference signals (RSs) (e.g., synchronization (SSBs), demodulation reference signals (DM-RSs), channel state information reference signals (CSI-RSs), etc.).

Example 500 depicts a first beam management procedure (e.g., such as a P1 CSI-RS beam management procedure). The first beam management procedure may be referred to as a beam selection procedure, an initial beam acquisition procedure, a beam sweeping procedure, a cell search procedure, a beam search procedure, and/or the like. In example 500, reference signals are configured to be transmitted from the BS 502 to UE 504. The reference signals may be configured to be periodic (e.g., using RRC signaling), semi-persistent (e.g., using media access control (MAC) control element (MAC-CE) signaling), and/or aperiodic (e.g., using downlink control information (DCI)).

As illustrated, the first beam management procedure may include BS 502 performing beam sweeping over multiple transmit (TX) beams 506. A transmit beam 506 is a beam that is used by a wireless communication device (e.g., a BS 502 and/or UE 504) for transmitting signals. For example, BS 502 may transmit a reference signal using each of the transmit beams 506 associated with BS 502 for beam management. To enable UE 504 to perform receive (RX) beam sweeping, BS 502 uses a transmit beam 506 to transmit (e.g., with repetitions) each reference signal at multiple times within a same resource set to enable UE 504 to sweep through receive beams 508 in multiple transmission instances. A receive beam 508 is a beam that is used by a wireless communication device for receiving signals. For example, if BS 502 has a set of N transmit beams 506 and UE 504 has a set of M receive beams 508, then the reference signal may be transmitted on each of the N transmit beams 506 M times such that UE 504 receives M instances of the reference signals per transmit beam 506. As a result, the first beam management procedure helps to enable UE 504 to measure a reference signal on different transmit beams 506, using different receive beams 508, to support the selection of a receive beam 508 for a transmit beam 506. UE 504 may report the measurements to BS 502 to enable BS 502 to select one or more beam pair(s) for communication between BS 502 and UE 504, as further described herein with respect to channel state feedback corresponding to receive beam hypotheses.

Example 510, illustrated in FIG. 5, depicts a second beam management procedure (e.g., such as a P2 CSI-RS beam management procedure). The second beam management procedure may be referred to as a beam refinement procedure, a BS beam refinement procedure, a TRP beam refinement procedure, a transmit beam refinement procedure, and/or the like.

As illustrated, the second beam management procedure includes BS 502 performing beam sweeping over one or more transmit beams 512. The transmit beam(s) 512 may be a subset of all transmit beams associated with BS 502 (e.g., determined based, at least in part, on measurements reported by UE 504 in connection with the first beam management procedure). BS 502 transmits a reference signal using each of the transmit beam(s) 512. UE 504 measures each reference signal using a single (e.g., a same) receive beam 514 (e.g., determined based, at least in part, on measurements performed in connection with the first beam management procedure). As such, the second beam management procedure may enable BS 502 to select a best transmit beam based on measurements of the reference signals (e.g., measured by UE 504 using the single receive beam 514) reported by UE 504.

Example 520, illustrated in FIG. 5, depicts a third beam management procedure (e.g., such as a P3 CSI-RS beam management procedure). The third beam management procedure may be referred to as a beam refinement procedure, a UE beam refinement procedure, a receive beam refinement procedure, and/or the like.

As illustrated, the third beam management procedure includes BS 502 transmitting one or more reference signals using a single transmit beam 522 (e.g., determined based, at least in part, on measurements reported by UE 504 in connection with the first beam management procedure and/or the second beam management procedure). To enable UE 504 to perform receive beam sweeping, BS 502 may use a transmit beam 522 to transmit (e.g., with repetitions) reference signals at multiple times within a same resource set such that UE 504 can sweep through one or more receive beams 524 in multiple transmission instances. The receive beam(s) 524 may be a subset of all receive beams associated with UE 504 (e.g., determined based on measurements performed in connection with the first beam management procedure and/or the second beam management procedure). The third beam management procedure helps to enable BS 502 and/or UE 504 to select a best receive beam 524 based on reported measurements received from UE 504 (e.g., of the reference signal of the transmit beam 522 using the one or more receive beams 524).

FIG. 5 is provided as an example of beam management procedures for determining transmit beam(s) and/or receive beam(s) for wireless communications between a UE and a network entity. Other examples of beam management procedures that differ from what is described with respect to FIG. 5, however, may be considered when determining transmit beam(s) and/or receive beam(s) for wireless communications.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

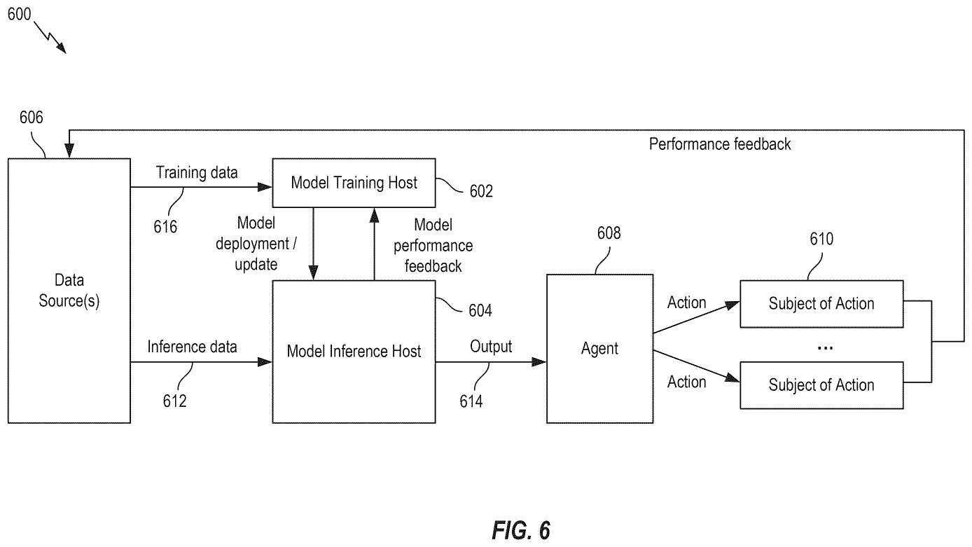

FIG. 6 is a diagram illustrating an example AI architecture 600 that may be used for AI/ML-based mobility as described herein. As illustrated, the architecture 600 includes multiple logical entities, such as a model training host 602, a model inference host 604, data source(s) 606, and an agent 608. The AI architecture may be used in any of various use cases for wireless communications, such as those listed above.

The model inference host 604, in the architecture 600, is configured to run an ML model based on inference data 612 provided by data source(s) 606. The model inference host 604 may produce an output 614 (e.g., a prediction or inference, such as a discrete or continuous value) based on the inference data 612, that is then provided as input to the agent 608. In certain aspects, the model inference host 604 may be an example of a model inference agent.

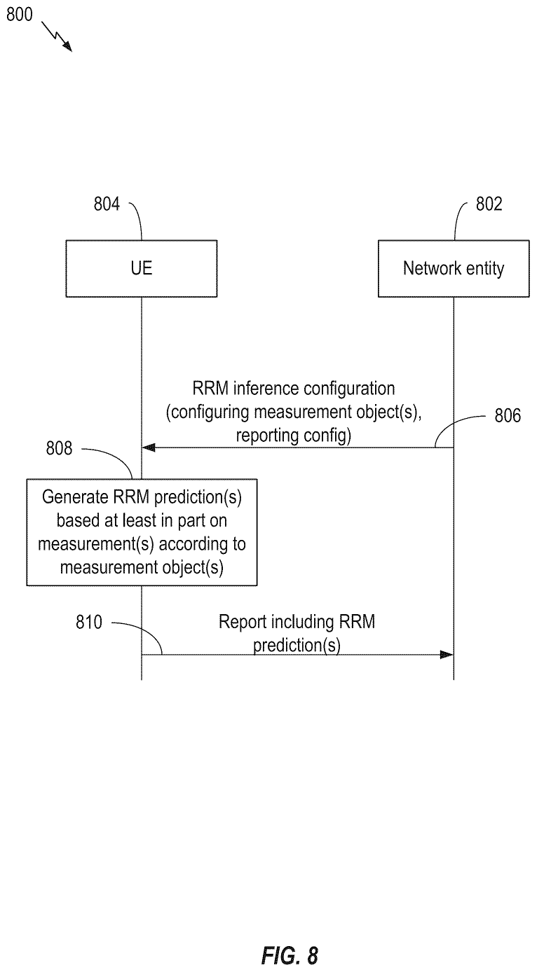

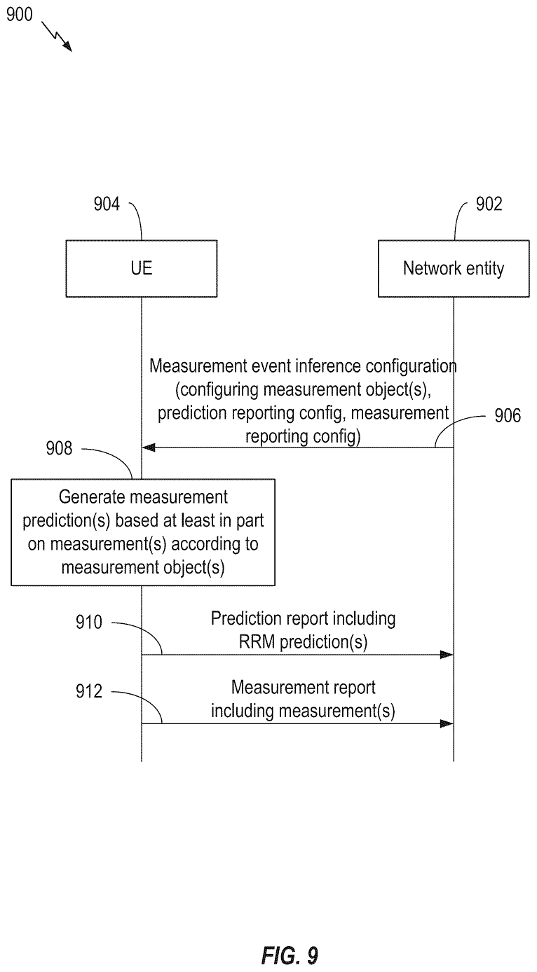

The agent 608 may be an element or an entity of a wireless communication system including, for example, a radio access network (RAN), a wireless local area network, a device-to-device (D2D) communications system (e.g., the BS 102 depicted and described with respect to FIG. 1, the first network entity 300 or the second network entity 302 depicted and described with respect to FIG. 3, a disaggregated base station depicted and described with respect to FIG. 2, a network entity 802 depicted and described with respect to FIG. 8, a network entity 902 depicted and described with respect to FIG. 9, the UE 104 depicted and described with respect to FIG. 1, the UE 304 depicted and described with respect to FIG. 3, the UE 804 depicted and described with respect to FIG. 8, or the UE 904 depicted and described with respect to FIG. 9). In certain examples, the agent 608 may be an example of a decision agent. In some examples, the agent 608 may be a UE, a base station, or any disaggregated network entity thereof including a CU, a DU, and/or an RU, an access point, a wireless station, a RIC in a cloud-based RAN, among some examples. Additionally, the type of agent 608 may also depend on the type of tasks performed by the model inference host 604, the type of inference data 612 provided to model inference host 604, and/or the type of output 614 produced by model inference host 604.

For example, if output 614 from the model inference host 604 is associated with beam management, the agent 608 may be or include a UE, a DU, or an RU. As another example, if output 614 from model inference host 604 is associated with transmission and/or reception scheduling, the agent 608 may be a CU or a DU.

After the agent 608 receives output 614 from the model inference host 604, agent 608 may determine whether to act based on the output. For example, if agent 608 is a DU or an RU and the output from model inference host 604 is associated with radio resource management (RRM) prediction or measurement event prediction, the agent 608 may determine whether to perform one or more operations (e.g., initiate a handover) based on the output 614. If the agent 608 determines to act based on the output 614, agent 608 may indicate the action to at least one subject of the action 610. For example, if the agent 608 determines to initiate a handover with respect to the subject of action 610 (e.g., a UE), the agent 608 may send a handover command to the subject of action 610 (e.g., a UE). As another example, the agent 608 may be a UE, the output 614 from model inference host 604 may be one or more predicted channel characteristics for one or more beams. For example, the model inference host 604 may predict channel characteristics for a set of beams based on the measurements of another set of beams. Based on the predicted channel characteristics, the agent 608, such as the UE, may send, to the subject of action 610, such as a BS, a request to switch to a different beam for communications. In some cases, the agent 608 and the subject of action 610 are the same entity.

The data sources 606 may be configured for collecting data that is used as training data 616 for training an ML model, or as inference data 612 for feeding an ML model inference operation. In particular, the data sources 606 may collect data from any of various entities (e.g., the UE and/or the BS), which may include the subject of action 610, and provide the collected data to a model training host 602 for ML model training. For example, after a subject of action 610 (e.g., a UE) receives a beam configuration from agent 608, the subject of action 610 may provide performance feedback associated with the beam configuration to the data sources 606, where the performance feedback may be used by the model training host 602 for monitoring and/or evaluating the ML model performance, such as whether the output 614, provided to agent 608, is accurate. In some examples, if the output 614 provided to agent 608 is inaccurate (or the accuracy is below an accuracy threshold), the model training host 602 may determine to modify or retrain the ML model used by model inference host 604, such as via an ML model deployment/update.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some aspects, an ML model is deployed at or on a network entity for AI/ML-based mobility. More specifically, a model inference host, such as model inference host 604 in FIG. 6, may be deployed at or on the network entity for AI/ML-based mobility.

In some other aspects, an ML model is deployed at or on a UE for AI/ML-based mobility. More specifically, a model inference host, such as model inference host 604 in FIG. 6, may be deployed at or on the UE for AI/ML-based mobility.

### Aspects Related to Artificial Intelligence-Aided Beam Management Procedures

Certain aspects described herein may be implemented, at least in part, using some form of AI, e.g., the process of using an ML model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

Aspects of the present disclosure may describe the performance of certain tasks and the technical solution of various technical problems by application of a specific type of ML model, such as an artificial neural network (ANN). It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such as “AI model,” “ML model,” “AI/ML model,” “trained ML model,” or the like are intended to be interchangeable.

AI/ML techniques have been introduced to help reduce the complexity involved in beam selection and the overhead associated with beam management without sacrificing system performance. For example, with the help of ML techniques, beam selection may be performed in a fraction of the time taken by conventional exhaustive search methods and with performance comparable to that of such methods.

In certain aspects, an ML model is deployed at or on a UE (e.g., such as UE 104 in FIG. 1), for example, for purposes of spatial domain (SD), temporal domain (TD), and/or frequency domain (FD) beam prediction. The TD refers to the analytic space in which signals are conveyed in terms of time, rather than frequency. The FD refers to the analytic space in which signals are conveyed in terms of frequency, rather than time. A scenario where the ML model, at or on the UE, is used to predict SD downlink beams for a set of A-beams based on measurement results of a set of B-beams may be referred to as a beam management case 1, or simply “BM-Case1.” Additionally, a scenario where the ML model, at or on the UE, is used to predict TD downlink beams for a set of A-beams based on the historic measurement results of a set of B-beams may be referred to as a beam management case 2, or simply “BM-Case2.” In general, ML may be used to predict characteristics associated with the set of A-beams, and the set of B-beams may be used for DL beam measurements as input data for the ML. For BM-Case1 and BM-Case2, the beams in the set of A-beams and the set of B-beams may be in the same Frequency Range (e.g., FR1 and/or FR2). In some cases, the set of B-beams may be a subset of the set of A-beams. There may be any number of beams in each of the set of A-beams and the set of B-beams. There may be quasi-colocation (QCL) relationships between the set of A-beams and the set of B-beams.

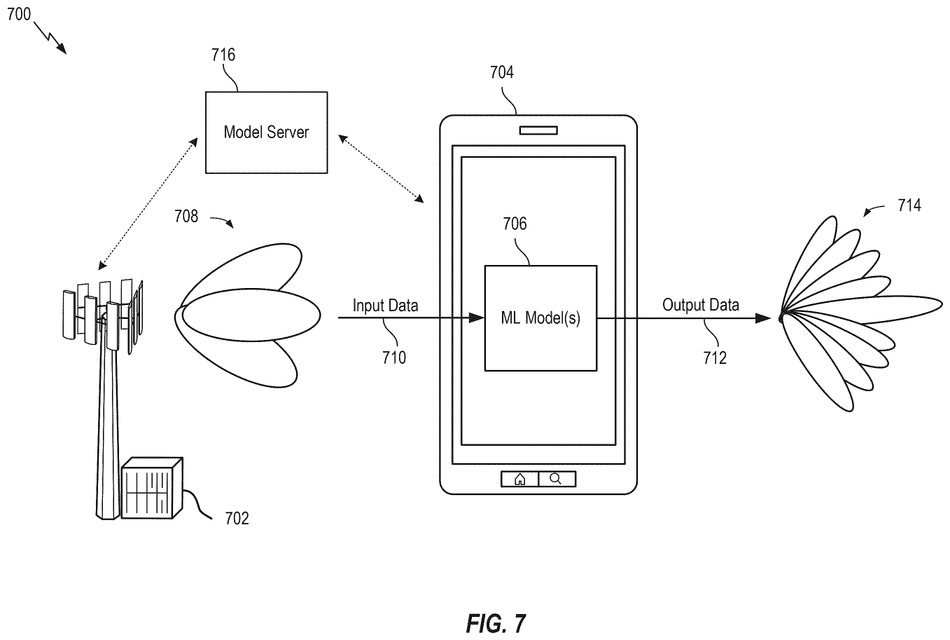

FIG. 7 is a diagram illustrating example beam prediction 700 by a UE 704 (e.g., a UE 104). In this example, an ML model 706 is deployed at or on UE 704 to enable UE 704 to make one or more beam predictions based on data input to ML model 706.

For example, a network entity (e.g., a base station or any disaggregated entity thereof) may transmit one or more signals (e.g., SSB(s), DM-RS(s), CSI-RS(s)), via a first set of transmit beams 708, in a first set of communication resources (e.g., an SSB resource, a DM-RS resource, and/or a CSI-RS resource). The UE 704 may perform measurements (e.g., L1-RSRP measurements and/or other measurements) of the one or more signals transmitted in the first set of communication resources, or a subset thereof, to obtain input data, which may include a first set of measurements 710 (sometimes referred to as parameters, channel characteristics, or channel properties). For example, each transmit beam 708 (or a subset thereof), from the first set of beams carrying the one or more signals, may be associated with one or more measurements 710 performed by UE 704. UE 704 may feed the first set of measurements 710 (e.g., L1 RSRP measurement values) as input to the ML model 706. The UE 704 may further feed information associated with the first set of beams and/or first set of communication resources (or a subset thereof). The information associated with the first set of beams may include a beam direction (e.g., a spatial direction), beam width, beam shape, and/or other characteristics of the respective beam.

The ML model 706 may provide output data, for example, including one or more predictions. More specifically, ML model 706 may provide one or more predicted measurement values 712 for a second set of communication resources associated with a second set of transmit beams 714. The one or more measurement values 712 may include predicted channel characteristics (e.g., predicted L1-RSRP measurement values) associated with the second set of communication resources, where the second set of communication resources are associated with the second set of transmit beams 714.

In some examples, the first set of beams 708 (e.g., that are measured) may be referred to as “Set B beams” and the second set of beams 714 (e.g., that are associated with predicted measurements for the second set of communication resources) may be referred to as “Set A beams.” Put another way, the “Set B beams” are a set of beams for which measurements are taken and used to determine input data based on such measurements for the ML model 706, whereas the “Set A beams” are a set of beams for which ML model 706 performs predictions.

In some examples, first set of beams 708 are a subset of the second set of beams 714. In some other examples, first set of beams 708 and second set of beams 714 are different beams and/or may be mutually exclusive sets. For example, first set of beams 708 may include wide beams (e.g., unrefined beams or beams having a beam width that satisfies a first threshold), and second set of beams 714 may include narrow beams (e.g., refined beams or beams having a beam width that satisfies a second threshold).

Use of the ML model 706 for beam prediction may reduce a quantity of beam measurements that are performed by UE 704, thereby conserving power at UE 704 and/or network resources that would have otherwise been used to measure all beams included in at least the first set of beams.

In some aspects, this type of prediction may be referred to as a codebook-based SD selection or prediction. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of the ML model 706 may include a point-direction, an angle of departure (AoD), and/or an angle of arrival (AoA) of a beam included in the second set of beams (e.g., the “Set A beams”). This type of prediction may be referred to as a non-codebook-based SD selection or prediction. The non-codebook-based prediction/selection may be associated with a serving beam refinement, and/or a link quality (e.g., CQI or PMI) and interference adaptation. As another example, multiple measurement reports and/or values, collected at different points in time, may be input to ML model 706. This may enable ML model 706 to output codebook-based and/or non-codebook-based predictions for a measurement value, an AoD, and/or an AoA, among other examples, of a beam at a future time. The output(s) of ML model 706, may facilitate initial access procedures, carrier aggregation (e.g., secondary cell setup), dual connectivity (e.g., secondary cell group (SCG) setup), beam refinement procedures (e.g., a P2 beam management procedure and/or a P3 beam management procedure as described above with respect to FIG. 5), link quality or interference adaptation procedures, beam failure and/or beam blockage predictions, and/or radio link failure predictions, among other examples.

In certain aspects, an output of ML model 706 may include a temporal beam prediction. The TD beam prediction may be associated with a serving beam refinement, a link quality (e.g., CQI or PMI) and interference adaptation, a beam failure/blockage prediction, and/or a radio link failure (RLF) prediction.

In certain aspects, ML model 706 performs SD downlink beam predictions for beams included in the “Set A beams” based on measurement results of beams included in the “Set B beams.” In some aspects, ML model 706 performs TD downlink beam prediction for beams included in the “Set A beams” based on historic measurement results of beams included in the “Set B beams.”

### Example Signaling of Inference Configuration for AI/ML-Based Mobility

FIG. 8 depicts a process flow 800 for communications in a network between a network entity 802 and a UE 804. In some aspects, the network entity 802 may be an example of the BS 102 depicted and described with respect to FIG. 1, the first network entity 300 or the second network entity 302 depicted and described with respect to FIG. 3, a disaggregated base station depicted and described with respect to FIG. 2, or the BS 702 depicted and described with respect to FIG. 7. Similarly, the UE 804 may be an example of UE 104 depicted and described with respect to FIG. 1, the UE 304 depicted and described with respect to FIG. 3, or the UE 704 depicted and described with respect to FIG. 7. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

At 806, the UE 804 receives, from the network entity 802, an RRM inference configuration. In some aspects, the RRM inference configuration configures a set of measurement objects. A measurement object comprises or indicates one or more frequency/time resources in which a characteristic is to be measured by the UE 804 or one or more frequency/time resources for which a characteristic is to be predicted by the UE 804. In some aspects, the RRM inference configuration configures a reporting configuration for reporting information associated with RRM predictions generated based at least in part on one or more measurements in accordance with the set of measurement objects.

In some aspects, the RRM inference configuration configures a set of measurement objects that comprises an absolute radio frequency channel number (ARFCN). That is, in some aspects, the RRM inference configuration configures the set of measurement objects as or to indicate an ARFCN. In some such aspects, the UE 804 may receive, from the network entity 802, an indication of a minimum quantity of cells or beams of the ARFCN to be measured in association with an intra-frequency RRM prediction (e.g., an RRM prediction for which cells or beams for which a characteristic is to be predicted are in the same frequency band as cells or beams for which the characteristic is to be measured). That is, the network entity 802 may in some aspects configure a minimum quantity of cells or beams of the ARFCN to be measured by the UE 804 in association with generating an intra-frequency RRM prediction. In some aspects, such an indication may be included in the RRM inference configuration. Additionally or alternatively, the indication may be included in another communication transmitted by the network entity 802 to the UE 804.

In some aspects, the RRM inference configuration configures a set of measurement objects that comprises a first set of cells or beams in a frequency band and a second set of cells or beams in the frequency band. That is, in some aspects, the RRM inference configuration configures the set of measurement objects as a first set of cells or beams (e.g., a set of cells or beams to be measured, which may be referred to as Set B cells or beams) in a frequency band and a second set of cells or beams (e.g., a set of cells or beams to be predicted, which may be referred to as Set A cells or beams).

In some aspects, the RRM inference configuration configures a set of measurement objects that comprises a first ARFCN list and a second ARFCN list. That is, in some aspects, the RRM inference configuration configures the set of measurement objects as a first ARFCN list (e.g., an ARFCN list for measurement) and a second ARFCN list (e.g., an ARFCN for prediction). In some such aspects, the UE 804 may receive, from the network entity 802, an indication of a minimum quantity of cells or beams to be measured (e.g., from the first ARFCN list) in association with an inter-frequency RRM prediction (e.g., an RRM prediction for which cells or beams for which a characteristic is to be predicted are in a different frequency band than cells or beams for which the characteristic is to be measured). Additionally or alternatively, the UE 804 may in some such aspects receive an indication of a minimum quantity of cells or beams to be predicted or a maximum quantity of cells or beams to be predicted (e.g., from the second ARFCN list) in association with generating the inter-frequency RRM prediction. That is, the network entity 802 may in some aspects configure a minimum quantity of cells or beams of the first ARFCN list to be measured by the UE 804, a minimum quantity of cells or beams of the second ARFCN list to be predicted by the UE 804, and/or a maximum quantity of cells or beams of the second ARFCN list to be predicted by the UE 804 in association with generating an inter-frequency RRM prediction. In some aspects, such indications may be included in the RRM inference configuration. Additionally or alternatively, the indication(s) may be included in another communication transmitted by the network entity 802 to the UE 804.

In some aspects, the RRM inference configuration configures a set of measurement objects that comprises a set of cells or beams from a first ARFCN list and a set of cells or beams from a second ARFCN list. That is, in some aspects, the RRM inference configuration configures the set of measurement objects as a set of cells or beams from a first ARFCN list (e.g., an ARFCN list for measurement) and a set of cells or beams from a second ARFCN list (e.g., an ARFCN for prediction).

In some aspects, the RRM inference configuration configures the set of measurement objects using a single measurement object identifier associated with a single measurement object for measurement and prediction. That is, in some aspects, the RRM inference configuration may configure one measurement object identifier (e.g., measObjectID) for cells or beams to be measured (e.g., Set B cells or beams) and for cells or beams to be predicted (e.g., Set A cells or beams). In some such aspects, a single measurement object (e.g., measObjectNR) may include a configuration for both Set A cells or beams and Set B cells or beams.

In some aspects, the RRM inference configuration configures the set of measurement objects using a first measurement object identifier associated with a first measurement object for measurement, a second measurement object identifier associated with a second measurement object for prediction, and a single measurement identifier associated with both the first measurement object for measurement and the second measurement object for prediction. That is, in some aspects, the RRM inference configuration may configure two measurement object identifiers (e.g., a first measurement object identifier for Set A cells or beams and a second measurement object identifier for Set B cells or beams), where the first measurement object and the second measurement object are associated with a single measurement identifier (e.g., measID). In some such aspects, an information element (IE) may be defined to carry the first measurement object identifier, the second measurement object identifier, the measurement identifier, or one or more other items of information, such as a reporting configuration identifier.

In some aspects, the RRM inference configuration configures the set of measurement objects using a first measurement object identifier associated with a first measurement object for measurement, a second measurement object identifier associated with a second measurement object for prediction, a first measurement identifier associated with the first measurement object for measurement, and a second measurement identifier associated with the second measurement object for prediction. That is, in some aspects, the RRM inference configuration may configure two measurement object identifiers (e.g., a first measurement object identifier for Set A cells or beams and a second measurement object identifier for Set B cells or beams) and two measurement identifiers (e.g., a first measurement identifier associated with the first measurement object identifier and a second measurement identifier associated with the second measurement object identifier). In some such aspect, a measurement result (e.g., MeasResult) may be configured to include the first measurement object identifier and the second measurement object identifier.

In some aspects, the reporting configuration indicates a manner in which the UE 804 is to report information associated with RRM predictions generated based at least in part on one or more measurements in the set of measurement objects.

In some aspects, the reporting configuration may indicate that the UE 804 is to report one or more RRM predictions using actual prediction values (e.g., actual values as predicted, rather than differential values with respect to a reference value).

Additionally or alternatively, the reporting configuration may in some aspects indicate that the UE 804 is to report one or more RRM predictions using differential values (e.g., values with respect to a reference value). In some such aspects, the reporting configuration may indicate that the UE 804 is to report each differential value with respect to a single reference value. For example, the single reference value may include “+20 dB”, and a differential value may include “−3 dB” such that an RRM prediction of +17 dB is reported. In some aspects, the UE 804 may be configured such that the single reference value is a highest value among values of measurements of all measurement types. For example, the single reference value may be configured to be a highest value (e.g., a largest RSRP) among cell measurements, SSB measurements, and CSI-RS measurements across all cells or beams (and across all instances in the case of temporal prediction). In some aspects, the UE 804 may be configured to include, in the report, time instance information of the cell or beam for which the highest value was measured. Further, in some aspects, the UE 804 may be configured to include, in the report, an indication of the measurement type (e.g., cell, SSB, or CSI-RS) associated with the single reference value.

Alternatively, in some such aspects, the reporting configuration may indicate that the UE 804 is to report a given differential value with respect to a particular reference value from a set of reference values, where the particular reference value is a highest value among values of measurements of a measurement type that matches a measurement type associated with the differential value. That is, the UE 804 may in some aspects be configured to consider reference values separately for each measurement type (e.g., such that the UE 804 determines a reference value for cell measurements, a reference value for SSB measurements, and reference value for CSI-RS measurements). As an example, the UE 804 may be configured such that a highest value among cell measurements across all cells (and across all instances in the case of temporal prediction) is to be used as a reference value for reporting cell values associated with RRM predictions. Continuing this example, the UE 804 may be configured such that a highest value among SSB measurements across all SSBs (and across all instances in the case of temporal prediction) is to be used as a reference value for reporting SSB values associated with RRM predictions. Continuing this example, the UE 804 may be configured such that a highest value among CSI-RS measurements across all CSI-RSs (and across all instances in the case of temporal prediction) is to be used as a reference value for reporting CSI-RS values associated RRM predictions.

In some aspects, the UE 804 may be configured with a threshold associated with reporting information associated with one or more RRM predictions. For example, the UE 804 may be configured (e.g., via RRC signaling or the reporting configuration) with a threshold for RRM prediction value reporting. In some aspects, the threshold may indicate that a given value associated with an RRM prediction is to be reported only if the value satisfies (e.g., is greater than or equal to) the threshold (e.g., such that the value is not reported if the value fails to satisfy the threshold).

In some aspects, the UE 804 may be configured with a configured range for reporting values associated with temporal predictions. For example, the UE 804 may be configured (e.g., via RRC signaling or the reporting configuration) with a configured range for measurement value reporting. In some aspects, the configured range may indicate that a value may be dropped from a report (e.g., not reported) based at least in part on the value being within the configured range (e.g., such that measurement values within an expected range are not reported, thereby reducing overhead).

In some aspects, the reporting configuration may configure the UE 804 to report one or more temporal predictions. In some such aspects, a reference time associated with the temporal prediction may be based on a last measurement occasion associated with one or more measurements based at least in part on which a temporal prediction is generated. That is, a reference time for a temporal prediction may in some aspects be configured as a latest measurement occasion of Set B cells or beams.

Additionally or alternatively, the reporting configuration may configure the UE 804 to report one or more intra-frequency RRM predictions or one or more inter-frequency RRM predictions. In some aspects, the one or more prediction values may include one or more predicted RSRPs, one or more predicted reference signal received qualities (RSRQs), one or more predicted signal-to-interference-plus-noise ratios (SINRs), or one or more predicted beams (e.g., CSI-RSs or SSBs), among other examples. In some such aspects, the UE 804 may be configured to report one or more prediction values associated with the one or more RRM predictions. In some such aspects, a reporting configuration identifier may be associated with reporting of the one or more intra-frequency RRM predictions or the one or more inter-frequency RRM predictions only (e.g., another reporting configuration identifier may be associated with reporting of measurement values, if reporting of measurement values is of interest to the network entity 802). Alternatively, the UE 804 may be configured to report one or more prediction values and one or more measurement values associated with the one or more prediction values. In some such aspects, a reporting configuration identifier may be associated with reporting of the one or more intra-frequency RRM predictions or the one or more inter-frequency RRM predictions and with reporting of the one or more measurement values. In some such aspects, the UE 804 may be configured to indicate, within the report, whether a given value is associated with a prediction or a measurement. In some aspects, if the one or more RRM predictions include a temporal prediction, the UE 804 may be configured to report a predicted RSRP over a plurality of time instances or over a time window.

At 808, the UE 804 generates one or more RRM predictions based at least in part on one or more measurements according to the set of measurement objects. In some aspects, the one or more RRM predictions include at least one spatial prediction. That is, in some aspects, the one or more RRM predictions may be spatial. Additionally or alternatively, the one or more RRM predictions may include one or more temporal predictions. That is, in some aspects, the one or more RRM predictions may be temporal. In some such aspects, a given temporal prediction may be associated with a plurality of time instances (e.g., N time instances, where N>1), or may be associated with a time window. In some aspects, a quantity of time instances in the plurality of time instances and/or the time window may be configured on the UE 804 by the network entity 802 (e.g., subject to UE capability). In some aspects, the one or more RRM predictions may include one or more intra-frequency RRM predictions. Additionally or alternatively, the one or more RRM predictions may include one or more inter-frequency RRM predictions.

In some aspects, as described above, the set of measurement objects includes an ARFCN. In some such aspects, to generate the one or more RRM predictions, the UE 804 may perform one or more measurements on a first subset of cells or beams in the ARFCN, and may generate (e.g., using an RRM prediction model configured or accessible by the UE 804) one or more RRM predictions (e.g., one or more intra-frequency RRM predictions) for a second subset of cells or beams in the ARFCN based at least in part on a result of the one or more measurements on the first subset of cells or beams. In some such aspects, the UE 804 may select (e.g., randomly, based on a configured order, or the like) the first subset of cells or beams and the second subset of cells or beams. Further, in some such aspects, a quantity of cells or beams in the first subset of cells or beams is in accordance with an indication (e.g., received from the network entity 802 as described above) of a minimum quantity of cells or beams to be measured.

In some aspects, as described above, the set of measurement objects includes a first set of cells or beams in a frequency band and a second set of cells or beams in the frequency band. In some such aspects, to generate the one or more RRM predictions, the UE 804 may perform one or more measurements on the first set of cells or beams, and may generate (e.g., using an RRM prediction model configured or accessible by the UE 804) one or more RRM predictions (e.g., one or more intra-frequency RRM predictions) for the second set of cells or beams based at least in part on a result of the one or more measurements on the first set of cells or beams. Of note, in such aspects, the network entity 802 configures the set of cells or beams to be measured and the set of cells or beams to be predicted (e.g., rather than the UE 804 selecting the set of cells or beams to be measured and the set of cells or beams to be predicted).

In some aspects, as described above, the set of measurement objects includes a first ARFCN list and a second ARFCN list. In some such aspects, to generate the one or more RRM predictions, the UE 804 may perform one or more measurements on a set of cells or beams from the first ARFCN list, and may generate (e.g., using an RRM prediction model configured or accessible by the UE 804) one or more RRM predictions (e.g., one or more inter-frequency RRM predictions) for a set of cells or beams from the second ARFCN list based at least in part on a result of the one or more measurements on the set of cells or beams from the first ARFCN list. In some such aspects, the UE 804 may select (e.g., randomly, based on a configured order, or the like) the first set of cells or beams from the first ARFCN list and the second set of cells or beams from the second ARFCN list. Further, in some such aspects, a quantity of cells or beams in the first set of cells or beams or a quantity of cells or beams in the second set of cells or beams are in accordance with applicable indications (e.g., received from the network entity 802 as described above), such as an indication of a minimum quantity of cells or beams to be measured, an indication of a minimum quantity of cells or beams to be predicted, or an indication of a maximum quantity of cells or beams to be predicted.

In some aspects, the set of measurement objects comprises a set of cells or beams from a first ARFCN list and a set of cells or beams from a second ARFCN list. In some such aspects, to generate the one or more RRM predictions, the UE 804 may perform one or more measurements on the set of cells or beams from the first ARFCN list, and may generate (e.g., using an RRM prediction model configured or accessible by the UE 804) one or more RRM predictions (e.g., one or more inter-frequency RRM predictions) for the set of cells or beams from the second ARFCN list based at least in part on a result of the one or more measurements on the set of cells or beams from the first ARFCN list. Of note, in such aspects, the network entity 802 configures the set of cells or beams to be measured and the set of cells or beams to be predicted (e.g., rather than the UE 804 selecting the set of cells or beams to be measured and the set of cells or beams to be predicted).

At 810, the UE 804 transmits, to the network entity 802, a report including information associated with the one or more RRM predictions, where the report is in accordance with the reporting configuration. That is, the UE 804 may generate, in accordance with the reporting configuration, a report including information associated with the one or more RRM predictions, and may transmit the report to the network entity 802.

In some aspects, in accordance with the reporting configuration, the information associated with the one or more RRM predictions (i.e., the information reported by the UE 804) includes one or more absolute values, such as a value explicitly indicating “+17 dB”. Additionally or alternatively, in accordance with the reporting configuration, the information associated with the one or more RRM predictions includes one or more differential values (such as a value of “−3 dB” when reporting an RRM prediction of +17 dB relative to a reference value of +20 dB). In some aspects, as described above, a differential value of the one or more differential values may be with respect to a single reference value. Additionally or alternatively, as described above, a given differential value may in some aspects be with respect to a particular reference value from a set of reference values.

In some aspects, in accordance with the reporting configuration, the information associated with the one or more RRM predictions includes one or more prediction values. Alternatively, in accordance with the reporting configuration, the information associated with the one or more RRM predictions includes one or more prediction values and one or more measurement values associated with the one or more prediction values. In some aspects, in the case of a temporal prediction, the information associated with the one or more RRM predictions includes a predicted RSRP over a plurality of time instances or over a time window.

In some aspects, in accordance with a configuration of the UE 804, the UE 804 may determine whether a value of a given RRM prediction satisfies a threshold, and may report or drop the value accordingly. For example, if the UE 804 determines that a given value satisfies the threshold configured on the UE 804, then the UE 804 may include the value in the report. Conversely, if the UE 804 determines that a given value fails to satisfy the threshold configured on the UE 804, then the UE 804 may refrain from including the value in the report (e.g., drop the value).

In some aspects, in accordance with a configuration of the UE 804, the UE 804 may determine whether a value of a result of a measurement associated with a temporal prediction is within a configured range, and may report or drop the value accordingly. For example, if the UE 804 determines that a given value of a result of measurement associated with a temporal prediction is within the configured range, then the UE 804 may include the value in the report. Conversely, if the UE 804 determines that a given value of a result of measurement associated with a temporal prediction is not within the configured range, then the UE 804 may refrain from including the value in the report (e.g., drop the value).

Note that the process flow illustrated in FIG. 8 is an example associated with inference configuration for AI/ML-based mobility, and aspects of the present disclosure may be applied to inference configuration for AI/ML-based mobility. Note that the process flow illustrated in FIG. 8 is described herein to facilitate an understanding of inference configuration for AI/ML-based mobility, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

FIG. 9 depicts a process flow 900 for communications in a network between a network entity 902 and a UE 904. In some aspects, the network entity 902 may be an example of the BS 102 depicted and described with respect to FIG. 1, the first network entity 300 or the second network entity 302 depicted and described with respect to FIG. 3, a disaggregated base station depicted and described with respect to FIG. 2 or the BS 702 depicted and described with respect to FIG. 7. Similarly, the UE 904 may be an example of UE 104 depicted and described with respect to FIG. 1, the UE 304 depicted and described with respect to FIG. 3 or the UE 704 depicted and described with respect to FIG. 7. However, in other aspects, UE 904 may be another type of wireless communications device and network entity 902 may be another type of network entity or network node, such as those described herein. Note that any operations or signaling illustrated with dashed lines may indicate that that operation or signaling is an optional or alternative example.

At 906, the UE 904 receives, from the network entity 902, a measurement event inference configuration. In some aspects, the measurement event inference configuration configures a set of measurement objects associated with generating measurement event predictions. A measurement object comprises one or more frequency/time resources in which a characteristic is to be measured by the UE 904 or one or more frequency/time resources for which a characteristic is to be predicted by the UE 904. In some aspects, the measurement event inference configuration configures a prediction reporting configuration for reporting information associated with measurement event predictions generated based at least in part on one or more measurements in the set of measurement objects. In some aspects, the measurement event inference configuration configures a measurement report configuration for reporting information associated with measurements based at least in part on which one or more measurement event predictions are generated.

In some aspects, the measurement event inference configuration configures a set of measurement objects that comprises an ARFCN. That is, in some aspects, the measurement event inference configuration configures the set of measurement objects as an ARFCN. In some such aspects, the UE 904 may receive, from the network entity 902, an indication of a minimum quantity of cells or beams of the ARFCN to be measured in association with an intra-frequency measurement event prediction (e.g., a measurement event prediction for which cells or beams for which a characteristic is to be predicted are in the same frequency band as cells or beams for which the a characteristic is to be measured). That is, the network entity 902 may in some aspects configure a minimum quantity of cells or beams of the ARFCN to be measured by the UE 904 in association with generating an intra-frequency measurement event prediction. In some aspects, such an indication may be included in the measurement event inference configuration. Additionally or alternatively, the indication may be included in another communication transmitted by the network entity 902 to the UE 904.

In some aspects, the measurement event inference configuration configures a set of measurement objects that comprises a first set of cells or beams in a frequency band and a second set of cells or beams in the frequency band. That is, in some aspects, the measurement event inference configuration configures the set of measurement objects as a first set of cells or beams (e.g., a set of cells or beams to be measured, which may be referred to as Set B cells or beams) in a frequency band and a second set of cells or beams (e.g., a set of cells or beams to be predicted, which may be referred to as Set A cells or beams).

In some aspects, the measurement event inference configuration configures a set of measurement objects that comprises a first ARFCN list and a second ARFCN list. That is, in some aspects, the measurement event inference configuration configures the set of measurement objects as a first ARFCN list (e.g., an ARFCN list for measurement) and a second ARFCN list (e.g., an ARFCN for prediction). In some such aspects, the UE 904 may receive, from the network entity 902, an indication of a minimum quantity of cells or beams to be measured (e.g., from the first ARFCN list) in association with an inter-frequency measurement event prediction (e.g., a measurement event prediction for which cells or beams for which a characteristic is to be predicted are in a different frequency band than cells or beams for which the characteristic is to be measured). Additionally or alternatively, the UE 904 may in some such aspects receive an indication of a minimum quantity of cells or beams to be predicted or a maximum quantity of cells or beams to be predicted (e.g., from the second ARFCN list) in association with generating the inter-frequency measurement event prediction. That is, the network entity 902 may in some aspects configure a minimum quantity of cells or beams of the first ARFCN list to be measured by the UE 904, a minimum quantity of cells or beams of the second ARFCN list to be predicted by the UE 904, and/or a maximum quantity of cells or beams of the second ARFCN list to be predicted by the UE 904 in association with generating an inter-frequency measurement event prediction. In some aspects, such indications may be included in the measurement event inference configuration. Additionally or alternatively, the indication(s) may be included in another communication transmitted by the network entity 902 to the UE 904.

In some aspects, the measurement event inference configuration configures a set of measurement objects that comprises a set of cells or beams from a first ARFCN list and a set of cells or beams from a second ARFCN list. That is, in some aspects, the measurement event inference configuration configures the set of measurement objects as a set of cells or beams from a first ARFCN list (e.g., an ARFCN list for measurement) and a set of cells or beams from a second ARFCN list (e.g., an ARFCN for prediction).

In some aspects, the measurement event inference configuration configures the set of measurement objects using a single measurement object identifier associated with a single measurement object for measurement and prediction. That is, in some aspects, the measurement event inference configuration may configure one measurement object identifier (e.g., measObjectID) for cells or beams to be measured (e.g., Set B cells or beams) and for cells or beams to be predicted (e.g., Set A cells or beams). In some such aspects, a single measurement object (e.g., measObjectNR) may include a configuration for both Set A cells or beams and Set B cells or beams.

In some aspects, the measurement event inference configuration configures the set of measurement objects using a first measurement object identifier (e.g., measObjectID) associated with a first measurement object (e.g., measObjectNR) for measurement, a second measurement object identifier associated with a second measurement object for prediction, and a single measurement identifier (e.g., measID) associated with both the first measurement object for measurement and the second measurement object for prediction. That is, in some aspects, the measurement event inference configuration may configure two measurement object identifiers (e.g., a first measurement object identifier for Set A cells or beams and a second measurement object identifier for Set B cells or beams), where the first measurement object and the second measurement object are associated with a single measurement identifier. In some such aspects, an IE may be defined to carry the first measurement object identifier, the second measurement object identifier, the measurement identifier, or one or more other items of information, such as a reporting configuration identifier).

In some aspects, the measurement event inference configuration configures the set of measurement objects using a first measurement object identifier (e.g., measObjectID) associated with a first measurement object (e.g., measObjectNR) for measurement, a second measurement object identifier associated with a second measurement object for prediction, a first measurement identifier (e.g., measID) associated with the first measurement object for measurement, and a second measurement identifier associated with the second measurement object for prediction. That is, in some aspects, the measurement event inference configuration may configure two measurement object identifiers (e.g., a first measurement object identifier for Set A cells or beams and a second measurement object identifier for Set B cells or beams) and two measurement identifiers (e.g., a first measurement identifier associated with the first measurement object identifier and a second measurement identifier associated with the second measurement object identifier). In some such aspect, a measurement result (e.g., MeasResult) may be configured to include the first measurement object identifier and the second measurement object identifier.

In some aspects, the prediction reporting configuration indicates a manner in which the UE 904 is to report information associated with measurement event predictions generated based at least in part on one or more measurements in the set of measurement objects. In some aspects, the prediction reporting configuration indicates a trigger event that is to cause the UE 904 to transmit a prediction report (e.g., such that the UE 904 transmits the prediction report upon detection of the trigger event). That is, in some aspects, the prediction reporting configuration may configure a trigger event for reporting measurement prediction results (e.g., similar to an A3 event, but without a time-to-trigger (TTT)-that is without a duration for which an A3 condition must hold before reporting is triggered). In some aspects, the prediction reporting configuration may support reporting of one or more prediction instances (e.g., without periodicity).

In some aspects, the prediction reporting configuration indicates a report quantity for the one or more measurement event predictions. In some aspects, the report quantity indicates a single measurement event prediction result (e.g., a prediction at a first time instance of prediction for an event associated with entering a condition). Additionally or alternatively, the report quantity may indicate a set of measurement event prediction results associated with a time window (e.g., a set of predictions, each associated with a time instance in a time window from a trigger event until an end of a TTT timeline).

In some aspects, the measurement reporting configuration indicates a manner in which the UE 904 is to report information associated with one or more measurements based at least in part on which the one or more measurement event predictions are generated.

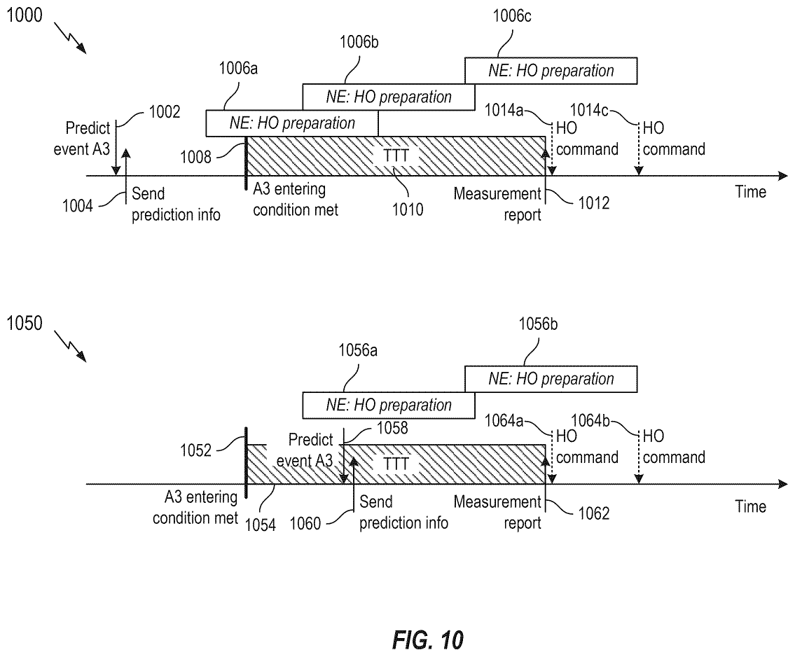

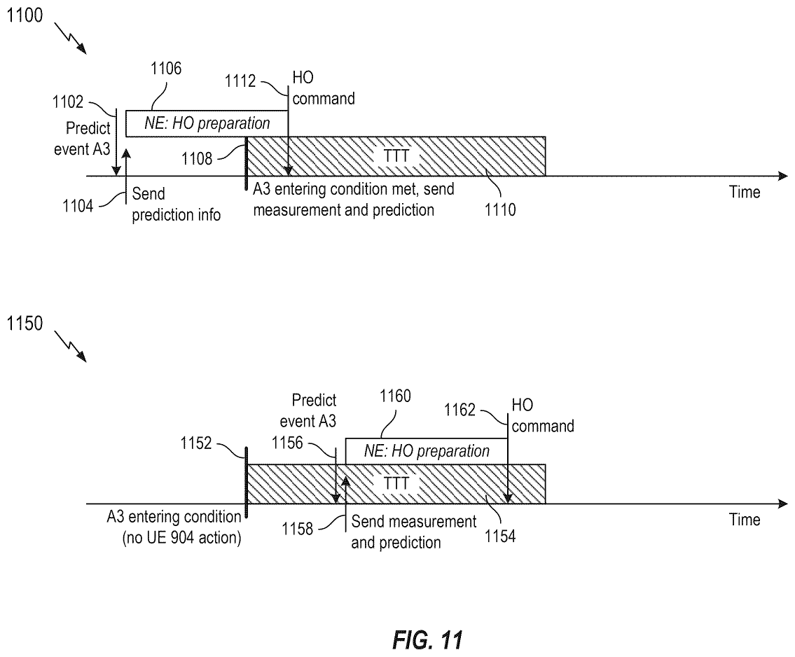

In some aspects, the prediction reporting configuration and the measurement reporting configuration are included in a single reporting configuration. That is, in some aspects, a single reporting configuration may be configured to include the prediction reporting configuration and the measurement reporting configuration. In some such aspects, the single reporting configuration may indicate one or more trigger events. The one or more trigger events may include, for example, a UE prediction trigger (e.g., such that reporting is triggered based on a prediction by the UE 904) or a network measurement trigger (e.g., such that reporting is triggered when the UE 904 enters an event condition based on a measurement). In some such aspects, a TTT associated with reporting may be set to 0 (e.g., when HO preparation is to start upon an event being predicted, as depicted and described below with respect to FIG. 11). Additionally, or alternatively, the TTT associated with reporting may be a non-zero value (e.g., when the network entity 902 is to transmit a HO command based on an actual measurement event, as depicted and described below with respect to FIG. 10)—meaning that the UE 904 is expected to report measurements after expiration of the TTT. In some aspects, the single reporting configuration indicates reporting contents associated with reporting the one or more measurement event predictions (e.g., a single instance of a measurement event or a set of instances of a measurement event over a time window or TTT) or the one or more measurements (e.g., one or more RSRPs, RSRQs, SINRs, or the like).

In some aspects, the prediction reporting configuration and the measurement reporting configuration are separate reporting configurations. That is, in some aspects, a first configuration may be configured for reporting predicted measurements (e.g., a single instance of a measurement event or a set of instances of a measurement event over a time window or TTT), and a second configuration may be configured for reporting the one or more measurements (e.g., RSRPs, RSRQs, SINRs, or the like). In some such aspects, the measurement event inference configuration further includes mapping information that links the prediction reporting configuration and the measurement reporting configuration. That is, the measurement event inference configuration may configure a link between the measurement reporting configuration and the prediction reporting configuration. In some such aspects, the UE 904 may be configured to transmit actual measurements (e.g., upon entering a condition) or a set of instances of predicted measurements.

At 908, the UE 904 generates one or more measurement event predictions based at least in part on one or more measurements according to the set of measurement objects. In some aspects, the one or more measurement event predictions may include one or more temporal predictions. That is, in some aspects, the one or more measurement event predictions may be temporal. In some such aspects, a given temporal prediction may be associated with a plurality of time instances (e.g., N time instances, where N>1), or may be associated with a time window. In some aspects, a quantity of time instances in the plurality of time instances and/or the time window may be configured on the UE 904 by the network entity 902 (e.g., subject to UE capability).

In some aspects, as described above, the set of measurement objects includes an ARFCN. In some such aspects, to generate the one or more measurement event predictions, the UE 904 may perform one or more measurements on a first subset of cells or beams in the ARFCN, and may generate (e.g., using a measurement event prediction model configured or accessible by the UE 904) one or more measurement event predictions (e.g., one or more intra-frequency measurement event predictions) for a second subset of cells or beams in the ARFCN based at least in part on a result of the one or more measurements on the first subset of cells or beams. In some such aspects, the UE 904 may select (e.g., randomly, based on a configured order, or the like) the first subset of cells or beams and the second subset of cells or beams. Further, in some such aspects, a quantity of cells or beams in the first subset of cells or beams is in accordance with an indication (e.g., received from the network entity 902 as described above) of a minimum quantity of cells or beams to be measured.

In some aspects, as described above, the set of measurement objects includes a first set of cells or beams in a frequency band and a second set of cells or beams in the frequency band. In some such aspects, to generate the one or more measurement event predictions, the UE 904 may perform one or more measurements on the first set of cells or beams, and may generate (e.g., using a measurement event prediction model configured or accessible by the UE 904) one or more measurement event predictions (e.g., one or more intra-frequency measurement event predictions) for the second set of cells or beams based at least in part on a result of the one or more measurements on the first set of cells or beams. Of note, in such aspects, the network entity 902 configures the set of cells or beams to be measured and the set of cells or beams to be predicted (e.g., rather than the UE 904 selecting the set of cells or beams to be measured and the set of cells or beams to be predicted).

In some aspects, as described above, the set of measurement objects includes a first ARFCN list and a second ARFCN list. In some such aspects, to generate the one or more measurement event predictions, the UE 904 may perform one or more measurements on a set of cells or beams from the first ARFCN list, and may generate (e.g., using a measurement event prediction model configured or accessible by the UE 904) one or more measurement event predictions (e.g., one or more inter-frequency measurement event predictions) for a set of cells or beams from the second ARFCN list based at least in part on a result of the one or more measurements on the set of cells or beams from the first ARFCN list. In some such aspects, the UE 904 may select (e.g., randomly, based on a configured order, or the like) the first set of cells or beams from the first ARFCN list and the second subset of cells from the second ARFCN list. Further, in some such aspects, a quantity of cells or beams in the first set of cells or beams or a quantity of cells or beams in the second set of cells or beams are in accordance with applicable indications (e.g., received from the network entity 902 as described above), such as an indication of a minimum quantity of cells or beams to be measured, an indication of a minimum quantity of cells or beams to be predicted, or an indication of a maximum quantity of cells or beams to be predicted.

In some aspects, the set of measurement objects comprises a set of cells or beams from a first ARFCN list and a set of cells or beams from a second ARFCN list. In some such aspects, to generate the one or more measurement event predictions, the UE 904 may perform one or more measurements on the set of cells or beams from the first ARFCN list, and may generate (e.g., using a measurement event prediction model configured or accessible by the UE 904) one or more measurement event predictions (e.g., one or more inter-frequency measurement event predictions) for the set of cells or beams from the second ARFCN list based at least in part on a result of the one or more measurements on the set of cells or beams from the first ARFCN list. Of note, in such aspects, the network entity 902 configures the set of cells or beams to be measured and the set of cells or beams to be predicted (e.g., rather than the UE 904 selecting the set of cells or beams to be measured and the set of cells or beams to be predicted).

At 910, the UE 904 transmits, to the network entity 902, a prediction report including information associated with the one or more measurement event predictions, where the report is in accordance with the prediction reporting configuration. That is, the UE 904 may generate, in accordance with the prediction reporting configuration, a prediction report including information associated with the one or more measurement event predictions, and may transmit the prediction report to the network entity 902.

In some aspects, the UE 904 may transmit the prediction report based at least in part on detecting a trigger event. For example, the prediction reporting configuration may configure the UE 904 with one or more trigger events, as described above. In some such aspects, the UE 904 may detect a trigger event indicated in the prediction reporting configuration, and may transmit the prediction report based at least in part on the detection of the trigger event.

At 912, the UE 904 transmits, to the network entity 902, a measurement report including information associated with the one or more measurements based at least in part on which the one or more measurement event predictions are generated. In some aspects, the measurement report is in accordance with the measurement reporting configuration. That is, in some aspects, the UE 904 may transmit, to the network entity 902 and in accordance with the measurement reporting configuration, a measurement report that includes information associated with one or more measurements performed by the UE 904 in association with generating the one or more measurement event predictions. In some aspects, the UE 904 may transmit the measurement report after transmitting the prediction report (e.g., the prediction report and the measurement report may be transmitted in separate communications). Additionally or alternatively, the UE 904 may in some aspects transmit the measurement report concurrently with transmitting the prediction report (e.g., the prediction report and the measurement report may be transmitted in the same communication).

Note that the process flow illustrated in FIG. 9 is an example associated with inference configuration for AI/ML-based mobility, and aspects of the present disclosure may be applied to inference configuration for AI/ML-based mobility. Note that the process flow illustrated in FIG. 9 is described herein to facilitate an understanding of inference configuration for AI/ML-based mobility, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

FIGS. 10 and 11 depict examples associated with an inference configuration for measurement event prediction and reporting as described with respect to FIG. 9.

FIG. 10 depicts an example in which the network entity 902 is configured to transmit a HO command based on an actual measurement event. In the examples 1000 and 1050, the UE 904 is configured with a measurement event inference configuration that configures a prediction reporting configuration and a measurement reporting configuration. Here, the prediction reporting configuration indicates that the UE 904 is to transmit a report including information associated with one or more measurement event predictions (e.g., a single instance of a measurement event or a set of instances of a measurement event) upon predicting a measurement event. Further, the measurement reporting configuration indicates that the UE 904 is to report one or more measurements (e.g., RSRPs, RSRQs, SINRs, or the like) upon expiration of a TTT that starts after a condition associated with the predicted measurement event is first satisfied. In some such aspects, the measurement event inference configuration may further include mapping information that links the prediction reporting configuration and the measurement reporting configuration (e.g., so that the measurement event prediction can be mapped to the measurements if, for example, multiple occurrences of the measurement event are predicted).

In the example 1000, at time 1002, a UE 904 predicts a measurement event (e.g., an A3 event). At time 1004, the UE 904 transmits, to a network entity 902 and in accordance with the prediction reporting configuration, a prediction report including information associated with the measurement event prediction. As indicated by time periods 1006a, 1006b, and 1006c, the network entity 902 performs HO preparation after receiving the prediction report. In this example, the three instances of time period 1006 (e.g., 1006a, 1006b, and 1006c) are meant to indicate that the network entity 902 can perform HO preparation at a time selected by the network entity 902 (e.g., the network entity 902 may choose to perform HO preparation during any of the three instances of the time period 1006). Continuing with this example, at time 1008, a condition associated with the predicted measurement event is first satisfied (e.g., an A3 entering condition is met). The TTT 1010 starts based at least in part on the condition associated with the predicted measurement event being first satisfied. At time 1012, the TTT 1010 expires, meaning that the condition associated with the predicted measurement event has persisted for the duration of the TTT 1010. Therefore, as shown, the UE 904 transmits, to the network entity 902 and in accordance with the measurement reporting configuration, a measurement report including information associated with one or more actual measurements based at least in part on which the measurement event was predicted. As further shown, the network entity 902 may then transmit a HO command to the UE 904 (e.g., at time 1014a if the network entity 902 performed HO preparation during time period 1006a or 1006b, or at time 1014c if the network entity 902 performed HO preparation during time period 1006c). Of note, in the example 1000, the UE 904 predicts the measurement event prior to the condition associated with the measurement event being first satisfied.

The example 1050 is an example in which the UE 904 predicts the measurement event after the condition associated with the measurement event is first satisfied (e.g., during the TTT 1010). At time 1052, a condition associated with the predicted measurement event is first satisfied (e.g., an A3 entering condition is met). The TTT 1054 starts based at least in part on the condition associated with the predicted measurement event being first satisfied. As indicated by time periods 1056a and 1056b, the network entity 902 performs HO preparation before or after receiving the prediction report. In this example, the two instances of time period 1056 (e.g., 1056a and 1056b) indicate that the network entity 902 may perform HO preparation at a time selected by the network entity 902. At time 1058, a UE 904 predicts the measurement event (e.g., the A3 event). At time 1060, the UE 904 transmits, to a network entity 902 and in accordance with the prediction reporting configuration, a prediction report including information associated with the measurement event prediction. At time 1062, the TTT 1054 expires, meaning that the condition associated with the predicted measurement event has persisted for the duration of the TTT 1054. Therefore, as shown, the UE 904 transmits, to the network entity 902 and in accordance with the measurement reporting configuration, a measurement report including information associated with one or more actual measurements based at least in part on which the measurement event was predicted. As further shown, the network entity 902 may then transmit a HO command to the UE 904 (e.g., at time 1064a if the network entity 902 performed HO preparation during time period 1056a, or at time 1064b if the network entity 902 performed HO preparation during time period 1056b).

In this way, the measurement event inference configuration described herein can be used in a scenario in which the network entity 902 is configured to transmit a HO command based on an actual measurement event.

FIG. 11 depicts an example in which the network entity 902 is configured to initiate HO preparation when an event is predicted, and to transmit a HO command when an event entering condition is satisfied and the condition is predicted to be satisfied for a duration of a TTT. In the examples 1100 and 1150, the UE 904 is configured with a measurement event inference configuration that configures a prediction reporting configuration and a measurement reporting configuration. Here, the prediction reporting configuration indicates that the UE 904 is to transmit a report including information associated with one or more measurement event predictions (e.g., a single instance of a measurement event or a set of instances of a measurement event) upon predicting a measurement event. Further, the measurement reporting configuration indicates that the UE 904 is to report one or more measurements (e.g., RSRPs, RSRQs, SINRs, or the like) upon detecting that a condition associated with the predicted measurement event is first satisfied (e.g., a condition that triggers a start of a TTT). In some such aspects, the measurement event inference configuration may further include mapping information that links the prediction reporting configuration and the measurement reporting configuration (e.g., so that the measurement event prediction can be mapped to the measurements if, for example, multiple occurrences of the measurement event are predicted). Of note, with respect to the example 1150, the measurement event inference configuration may include a single configuration including the prediction reporting configuration and the measurement reporting configuration, or may include separate configurations for the prediction reporting configuration and the measurement reporting configuration.

In the example 1100, at time 1102, a UE 904 predicts a measurement event (e.g., an A3 event). At time 1104, the UE 904 transmits, to a network entity 902 and in accordance with the prediction reporting configuration, a prediction report including information associated with the measurement event prediction. As indicated by reference 1106, the network entity 902 performs HO preparation after receiving the prediction report. At time 1108, a condition associated with the predicted measurement event is first satisfied (e.g., an A3 entering condition is met). The TTT 1110 starts based at least in part on the condition associated with the predicted measurement event being first satisfied. As further indicated, at time 1108, upon the condition being first satisfied, the UE 904 transmits, to the network entity 902 and in accordance with the measurement reporting configuration, a measurement report including information associated with one or more actual measurements based at least in part on which the measurement event was predicted. At time 1112, the network entity 902 completes HO preparation and transmits a HO command to the UE 904 (e.g., prior to expiration of the TTT 1110). Of note, in the example 1100, the UE 904 predicts the measurement event prior to the condition associated with the measurement event being first satisfied.

The example 1150 is an example in which the UE 904 predicts the measurement event after to the condition associated with the measurement event is first satisfied (e.g., during a TTT 1154). At time 1152, a condition associated with the predicted measurement event is first satisfied (e.g., an A3 entering condition is met). As shown, no UE action is performed at time 1152 with respect to measurement event prediction or reporting. The TTT 1154 starts based at least in part on the condition associated with the predicted measurement event being first satisfied. At time 1156, the UE 904 predicts the measurement event (e.g., the A3 event). At time 1158, the UE 904 transmits, to a network entity 902 and in accordance with the prediction reporting configuration and the measurement reporting configuration, a prediction reporting including information associated with the measurement event prediction and a measurement report including information associated with one or more actual measurements based at least in part on which the measurement event was predicted. As indicated by reference 1160, the network entity 902 performs HO preparation after receiving the prediction report and the measurement report. At time 1162, the network entity 902 completes HO preparation and transmits a HO command to the UE 904 (e.g., prior to expiration of the TTT 1154).

In this way, the measurement event inference configuration described herein can be used in a scenario in which the network entity 902 is configured to initiate HO preparation when an event is predicted, and to transmit a HO command when an event entering condition is satisfied and the condition is predicted to be satisfied for a duration of a TTT.

### Example Operations of a User Equipment

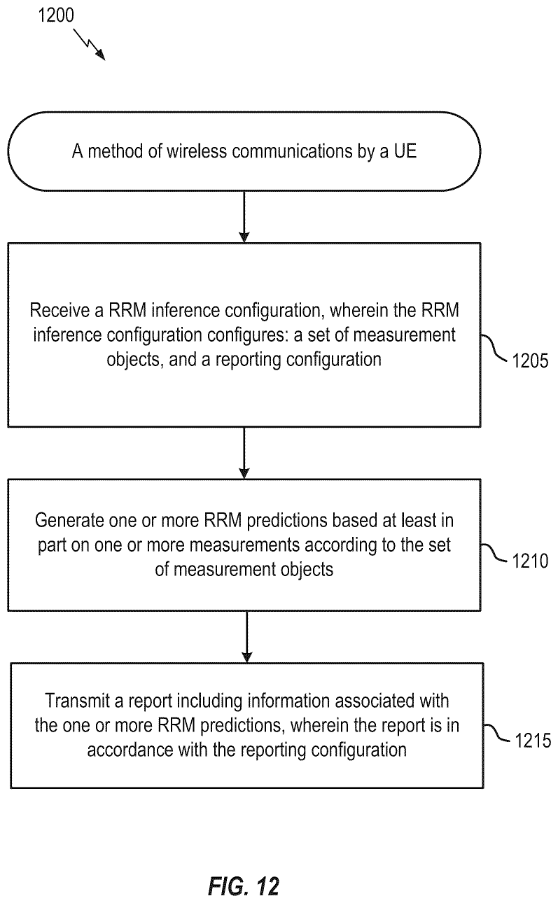

FIG. 12 shows a method 1200 for wireless communications by a UE, such as UE 104 of FIG. 1 or UE 304 of FIG. 3.

Method 1200 begins at block 1205 with receiving an RRM inference configuration, wherein the RRM inference configuration configures: a set of measurement objects; and a reporting configuration. For example, the UE 804 may receive an RRM inference configuration, as depicted and described with respect to reference 806 of FIG. 8.

Method 1200 then proceeds to block 1210 with generating one or more RRM predictions based at least in part on one or more measurements according to the set of measurement objects. For example, the UE 804 may generate one or more RRM predictions based at least in part on one or more measurements according to the set of measurement objects, as depicted and described with respect to reference 808 of FIG. 8

Method 1200 then proceeds to block 1215 with transmitting a report including information associated with the one or more RRM predictions, wherein the report is in accordance with the reporting configuration. For example, the UE 804 may transmit a report including information associated with the one or more RRM predictions, as depicted and described with respect to reference 810 of FIG. 8

In some aspects, the set of measurement objects comprises an ARFCN, wherein block 1210 includes: performing the one or more measurements on a first subset of cells or beams in the ARFCN, and generating an intra-frequency RRM prediction for a second subset of cells or beams in the ARFCN based at least in part on a result of the one or more measurements on the first subset of cells or beams.

In some aspects, method 1200 further includes receiving an indication of a minimum quantity of cells or beams to be measured in association with the intra-frequency RRM prediction, wherein a quantity of cells or beams in the first subset of cells or beams is in accordance with the indication.

In some aspects, the set of measurement objects comprises a first set of cells or beams in a frequency band and a second set of cells or beams in the frequency band, wherein block 1210 includes: performing the one or more measurements on the first set of cells or beams, and generating an intra-frequency RRM prediction for the second set of cells or beams based at least in part on a result of the one or more measurements on the first set of cells or beams.

In some aspects, the set of measurement objects comprises a first ARFCN list and a second ARFCN list, wherein block 1210 includes: performing the one or more measurements on a set of cells or beams from the first ARFCN list, and generating an inter-frequency RRM prediction for a set of cells or beams from the second ARFCN list based at least in part on a result of the one or more measurements on the set of cells or beams from the first ARFCN list.

In some aspects, method 1200 further includes receiving a first indication of a minimum quantity of cells or beams to be measured, receiving a second indication of at least one of: a minimum quantity of cells or beams to be predicted, or a maximum quantity of cells or beams to be predicted, wherein a quantity of cells or beams in the set of cells or beams from the first ARFCN list is in accordance with the first indication and a quantity of cells or beams in the set of cells or beams from the second ARFCN list is in accordance with the second indication.

In some aspects, the set of measurement objects comprises a set of cells or beams from a first ARFCN list and a set of cells or beams from a second ARFCN list, wherein block 1210 includes: performing the one or more measurements on the set of cells or beams from the first ARFCN list, and generating an inter-frequency RRM prediction for the set of cells or beams from the second ARFCN list based at least in part on a result of the one or more measurements on the set of cells or beams from the first ARFCN list.

In some aspects, the one or more RRM predictions include at least one spatial prediction.

In some aspects, the one or more RRM predictions include at least one temporal prediction associated with a plurality of time instances or a time window.

In some aspects, method 1200 further includes determining that a value of an RRM prediction, of the one or more RRM predictions, satisfies a threshold, wherein block 1215 includes transmitting the report including the value of the RRM prediction based at least in part on the value of the RRM prediction satisfying the threshold.

In some aspects, method 1200 further includes determining that a value of a result of a measurement associated with a temporal prediction, of the one or more RRM predictions, is within a configured range, wherein block 1215 includes dropping the value from the report based at least in part on the value being within the configured range.

In some aspects, the RRM inference configuration configures the set of measurement objects using a single measurement object identifier associated with a single measurement object for measurement and prediction.

In some aspects, the RRM inference configuration configures the set of measurement objects using a first measurement object identifier associated with a first measurement object for measurement, a second measurement object identifier associated with a second measurement object for prediction, and a single measurement identifier associated with both the first measurement object for measurement and the second measurement object for prediction.

In some aspects, the RRM inference configuration configures the set of measurement objects using a first measurement object identifier associated with a first measurement object for measurement, a second measurement object identifier associated with a second measurement object for prediction, a first measurement identifier associated with the first measurement object for measurement, and a second measurement identifier associated with the second measurement object for prediction.

In some aspects, the information associated with the one or more RRM predictions includes one or more actual prediction values.

In some aspects, the information associated with the one or more RRM predictions includes one or more differential values.

In some aspects, a differential value of the one or more differential values is with respect to a single reference value, wherein the single reference value is a highest value among values of measurements of all measurement types.

In some aspects, a differential value of the one or more differential values is with respect to a particular reference value from a set of reference values, wherein the particular reference value is a highest value among values of measurements of a measurement type that matches a measurement type associated with the differential value.

In some aspects, the one or more RRM predictions include a temporal prediction, wherein a reference time associated with the temporal prediction is based on a last measurement occasion associated with the one or more measurements based at least in part on which the temporal prediction is generated.

In some aspects, the one or more RRM predictions include at least one intra-frequency RRM prediction or at least one inter-frequency RRM prediction, wherein the information associated with the one or more RRM predictions includes one or more prediction values.

In some aspects, the one or more prediction values include at least one of: a predicted RSRP, a predicted RSRQ, a predicted SINR, or a predicted beam.

In some aspects, the one or more RRM predictions include at least one intra-frequency RRM prediction or at least one inter-frequency RRM prediction, wherein the information associated with the one or more RRM predictions includes one or more prediction values and one or more measurement values associated with the one or more prediction values.

In some aspects, the one or more RRM predictions include at least one temporal prediction, wherein the information associated with the one or more RRM predictions includes a predicted RSRP over a plurality of time instances or over a time window.

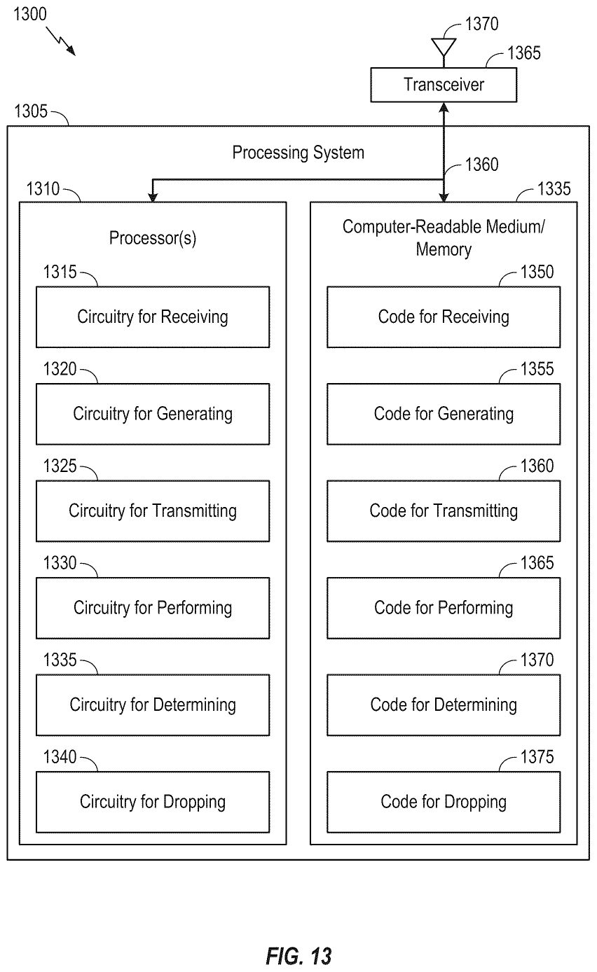

In some aspects, method 1200, or any aspect related to it, may be performed by an apparatus, such as communications device 1300 of FIG. 13, which includes various components operable, configured, or adapted to perform the method 1200. Communications device 1300 is described below in further detail.

In some aspects, the techniques for inference configuration for AI/ML-based mobility depicted and described with respect to the method 1200 may enable improved wireless communications performance, such as such as smooth connectivity, lower latency, or improved quality of service that can be achieved through AI/ML-based mobility. The improved wireless communication performance may be attributable to the method 1200, for example, due to the provisioning of an inference configuration for RRM prediction performance and reporting that enables AI/ML based mobility.

Note that FIG. 12 is just one example of a method, and other methods including fewer, additional, or alternative operations are possible consistent with this disclosure.

### Example Communications Device

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1385 (e.g., a transmitter and/or a receiver). The transceiver 1385 is configured to transmit and receive signals for the communications device 1300 via an antenna 1390, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1345. In various aspects, the one or more processors 1310 may be representative of the one or more processors 318 described with respect to FIG. 3. The one or more processors 1310 are coupled to a computer-readable medium/memory 1345 via a bus 1380. In some aspects, the computer-readable medium/memory 1345 may be representative of the one or more memories 320 described with respect to FIG. 3. The computer-readable medium/memory 1345 is a non-transitory computer-readable medium/memory. In certain aspects, the computer-readable medium/memory 1345 is configured to store instructions (e.g., computer-executable code), that when executed by the one or more processors 1310, cause the one or more processors 1310 to perform the method 1200 described with respect to FIG. 12, or any aspect related to it, including any operations described in relation to FIG. 12. Note that reference to a processor performing a function of communications device 1300 may include one or more processors performing that function of communications device 1300, such as in a distributed fashion.

In the depicted example, computer-readable medium/memory 1345 stores code (e.g., executable instructions), including code for receiving 1350, code for generating 1355, code for transmitting 1360, code for performing 1365, code for determining 1370, and code for dropping 1375. Processing of the code 1350-1375 may enable and cause the communications device 1300 to perform the method 1200 described with respect to FIG. 12, or any aspect related to it. For instance, in some aspects, code for receiving 1350 includes code for receiving an RRM inference configuration, wherein the RRM inference configuration configures: a set of measurement objects, and a reporting configuration. In some aspects, code for generating 1355 includes code for generating one or more RRM predictions based at least in part on one or more measurements according to the set of measurement objects. In some aspects, code for transmitting 1360 includes code for transmitting a report including information associated with the one or more RRM predictions, wherein the report is in accordance with the reporting configuration.

The one or more processors 1310 include circuitry configured to implement (e.g., execute) the code stored in the computer-readable medium/memory 1345, including circuitry for receiving 1315, circuitry for generating 1320, circuitry for transmitting 1325, circuitry for performing 1330, circuitry for determining 1335, and circuitry for dropping 1340. Processing with circuitry 1315-1340 may enable and cause the communications device 1300 to perform the method 1200 described with respect to FIG. 12, or any aspect related to it. For instance, in some aspects, circuitry for receiving 1315 includes circuitry for receiving an RRM inference configuration, wherein the RRM inference configuration configures: a set of measurement objects, and a reporting configuration. In some aspects, circuitry for generating 1320 includes circuitry for generating one or more RRM predictions based at least in part on one or more measurements according to the set of measurement objects. In some aspects, circuitry for transmitting 1325 includes circuitry for transmitting a report including information associated with the one or more RRM predictions, wherein the report is in accordance with the reporting configuration.

More generally, means for communicating, transmitting, sending or outputting for transmission may include the one or more transceivers 324, one or more antenna 322 and/or processing system 316 of the UE 304 illustrated in FIG. 3, transceiver 1385 and/or antenna 1390 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1385 and/or antenna 1390 of the communications device 1300 in FIG. 13, and/or one or more processors 1310 of the communications device 1300 in FIG. 13.

### Example Operations of a Network Entity

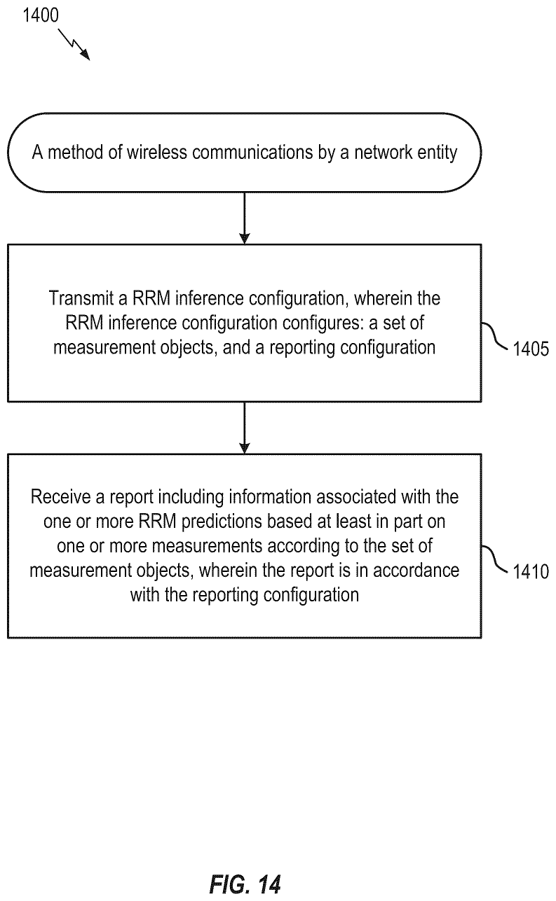

FIG. 14 shows a method 1400 for wireless communications by a network entity, such as BS 102 of FIG. 1, a first network entity 300 or second network entity 302 of FIG. 3, or a disaggregated base station as discussed with respect to FIG. 2.

Method 1400 begins at block 1405 with transmitting an RRM inference configuration, wherein the RRM inference configuration configures: a set of measurement objects; and a reporting configuration. For example, the network entity 802 may transmit an RRM inference configuration, as depicted and described with respect to reference 806 of FIG. 8.

Method 1400 then proceeds to block 1410 with receiving a report including information associated with the one or more RRM predictions based at least in part on one or more measurements according to the set of measurement objects, wherein the report is in accordance with the reporting configuration. For example, the network entity 802 may receive a report including information associated with the one or more RRM predictions based at least in part on one or more measurements according to the set of measurement objects, as depicted and described with respect to reference 810 of FIG. 8

In some aspects, the set of measurement objects comprises an ARFCN.

In certain aspects, method 1400 further includes transmitting an indication of a minimum quantity of cells or beams of the ARFCN to be measured in association with an intra-frequency RRM prediction.

In some aspects, the set of measurement objects comprises a first set of cells or beams in a frequency band and a second set of cells or beams in the frequency band.

In some aspects, the set of measurement objects comprises a first ARFCN list and a second ARFCN list.

In certain aspects, method 1400 further includes transmitting a first indication of a minimum quantity of cells or beams of the first ARFCN list to be measured, transmitting a second indication of at least one of: a minimum quantity of cells or beams of the second ARFCN list to be predicted, or a maximum quantity of cells or beams of the second ARFCN list to be predicted.

In some aspects, the set of measurement objects comprises a set of cells or beams from a first ARFCN list and a set of cells or beams from a second ARFCN list.

In some aspects, the one or more RRM predictions include at least one spatial prediction.

In some aspects, the one or more RRM predictions include at least one temporal prediction associated with a plurality of time instances or a time window.

In some aspects, the report includes a value of an RRM prediction, of the one or more RRM predictions, based at least in part on the value of the RRM prediction satisfying a threshold.

In some aspects, the RRM inference configuration configures the set of measurement objects using a single measurement object identifier associated with a single measurement object for measurement and prediction.

In some aspects, the RRM inference configuration configures the set of measurement objects using a first measurement object identifier associated with a first measurement object for measurement, a second measurement object identifier associated with a second measurement object for prediction, and a single measurement identifier associated with both the first measurement object for measurement and the second measurement object for prediction.

In some aspects, the RRM inference configuration configures the set of measurement objects using a first measurement object identifier associated with a first measurement object for measurement, a second measurement object identifier associated with a second measurement object for prediction, a first measurement identifier associated with the first measurement object for measurement, and a second measurement identifier associated with the second measurement object for prediction.

In some aspects, the information associated with the one or more RRM predictions includes one or more actual prediction values.

In some aspects, the information associated with the one or more RRM predictions includes one or more differential values.

In some aspects, a differential value of the one or more differential values is with respect to a single reference value, wherein the single reference value is a highest value among values of measurements of all measurement types.

In some aspects, a differential value of the one or more differential values is with respect to a particular reference value from a set of reference values, wherein the particular reference value is a highest value among values of measurements of a measurement type that matches a measurement type associated with the differential value.

In some aspects, the one or more RRM predictions include a temporal prediction, wherein a reference time associated with the temporal prediction is based on a last measurement occasion associated with the one or more measurements based at least in part on which the temporal prediction is generated.

In some aspects, the one or more RRM predictions include at least one intra-frequency RRM prediction or at least one inter-frequency RRM prediction, wherein the information associated with the one or more RRM predictions includes one or more prediction values.

In some aspects, the one or more prediction values include at least one of: a predicted RSRP, a predicted RSRQ, a predicted SINR, or a predicted beam.

In some aspects, the one or more RRM predictions include at least one intra-frequency RRM prediction or at least one inter-frequency RRM prediction, wherein the information associated with the one or more RRM predictions includes one or more prediction values and one or more measurement values associated with the one or more prediction values.

In some aspects, the one or more RRM predictions include at least one temporal prediction, wherein the information associated with the one or more RRM predictions includes a predicted RSRP over a plurality of time instances or over a time window.

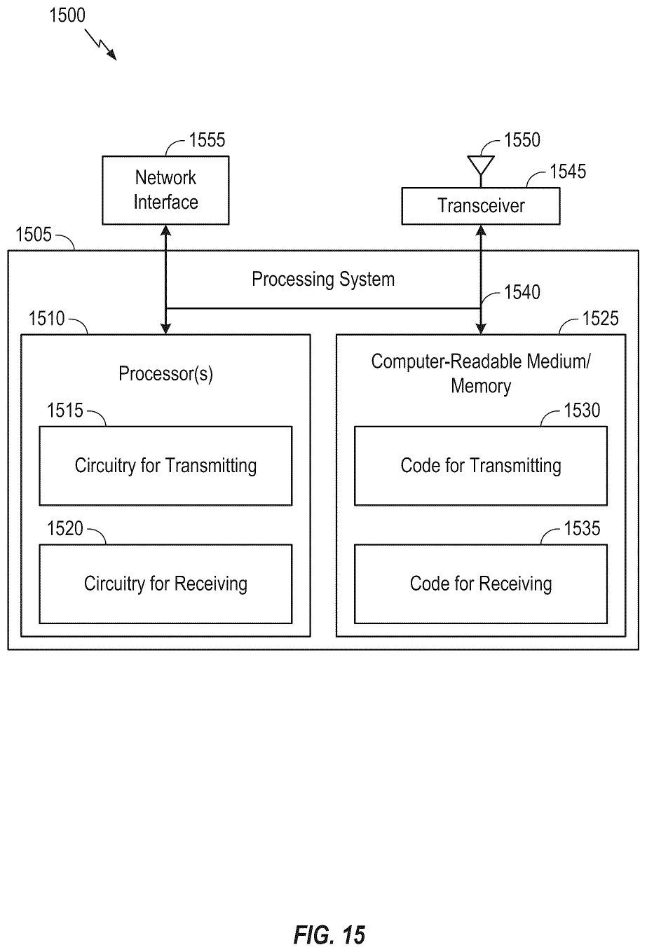

In some aspects, method 1400, or any aspect related to it, may be performed by an apparatus, such as communications device 1500 of FIG. 15, which includes various components operable, configured, or adapted to perform the method 1400. Communications device 1500 is described below in further detail.

In some aspects, the techniques for inference configuration for AI/ML-based mobility depicted and described with respect to the method 1400 may enable improved wireless communications performance, such as such as smooth connectivity, lower latency, or improved quality of service that can be achieved through AI/ML-based mobility. The improved wireless communication performance may be attributable to the method 1400, for example, due to the provisioning of an inference configuration for RRM prediction performance and reporting that enables AI/ML based mobility.

Note that FIG. 14 is just one example of a method, and other methods including fewer, additional, or alternative operations are possible consistent with this disclosure.

### Example Communications Device

FIG. 15 depicts aspects of an example communications device configured for wireless communications. In some aspects, communications device 1500 is a network entity, such as BS 102 of FIG. 1, first network entity 300 or second network entity 302 of FIG. 3, or a disaggregated base station as discussed with respect to FIG. 2.

The communications device 1500 includes a processing system 1505 coupled to a transceiver 1545 (e.g., a transmitter and/or a receiver) and/or a network interface 1555. The transceiver 1545 is configured to transmit and receive signals for the communications device 1500 via an antenna 1550, such as the various signals as described herein. The network interface 1555 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510 and a computer-readable medium/memory 1525. In various aspects, one or more processors 1510 may be representative of the one or more processors 308, as described with respect to FIG. 3. The one or more processors 1510 are coupled to the computer-readable medium/memory 1525 via a bus 1540. In certain aspects, the computer-readable medium/memory 1525 is configured to store instructions (e.g., computer-executable code), including code 1530 and 1535, that when executed by the one or more processors 1510, cause the one or more processors 1510 to perform the method 1400 described with respect to FIG. 14, or any aspect related to it, including any operations described in relation to FIG. 14. The computer-readable medium/memory 1525 is a non-transitory computer-readable medium/memory. Note that reference to a processor of communications device 1500 performing a function may include one or more processors of communications device 1500 performing that function, such as in a distributed fashion.

In the depicted example, the computer-readable medium/memory 1525 stores code (e.g., executable instructions), including code for transmitting 1530 and code for receiving 1535. Processing of the code 1530 and 1535 may enable and cause the communications device 1500 to perform the method 1400 described with respect to FIG. 14, or any aspect related to it. For instance, in some aspects, code for transmitting 1530 includes code for transmitting an RRM inference configuration, wherein the RRM inference configuration configures: a set of measurement objects, and a reporting configuration. In some aspects, code for receiving 1535 includes code for receiving a report including information associated with the one or more RRM predictions based at least in part on one or more measurements according to the set of measurement objects, wherein the report is in accordance with the reporting configuration.

The one or more processors 1510 include circuitry configured to implement (e.g., execute) the code stored in the computer-readable medium/memory 1525, including circuitry for transmitting 1515 and circuitry for receiving 1520. Processing with circuitry 1515 and 1520 may enable and cause the communications device 1500 to perform the method 1400 described with respect to FIG. 14, or any aspect related to it. For instance, in some aspects, circuitry for transmitting 1515 includes circuitry for transmitting an RRM inference configuration, wherein the RRM inference configuration configures: a set of measurement objects, and a reporting configuration. In some aspects, circuitry for receiving 1520 includes circuitry for receiving a report including information associated with the one or more RRM predictions based at least in part on one or more measurements according to the set of measurement objects, wherein the report is in accordance with the reporting configuration.

Various components of the communications device 1500 may provide means for performing the method 1400 described with respect to FIG. 14, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1545, antenna 1550, and/or network interface 1555 of the communications device 1500 in FIG. 15, and/or one or more processors 1510 of the communications device 1500 in FIG. 15. Means for communicating, receiving or obtaining may include the one or more transceivers 312, one or more antennas 314, and/or processing system 306 of the first network entity 300 or the second network entity 302 illustrated in FIG. 3, transceiver 1545, antenna 1550, and/or network interface 1555 of the communications device 1500 in FIG. 15, and/or one or more processors 1510 of the communications device 1500 in FIG. 15.

### Example Operations of a User Equipment

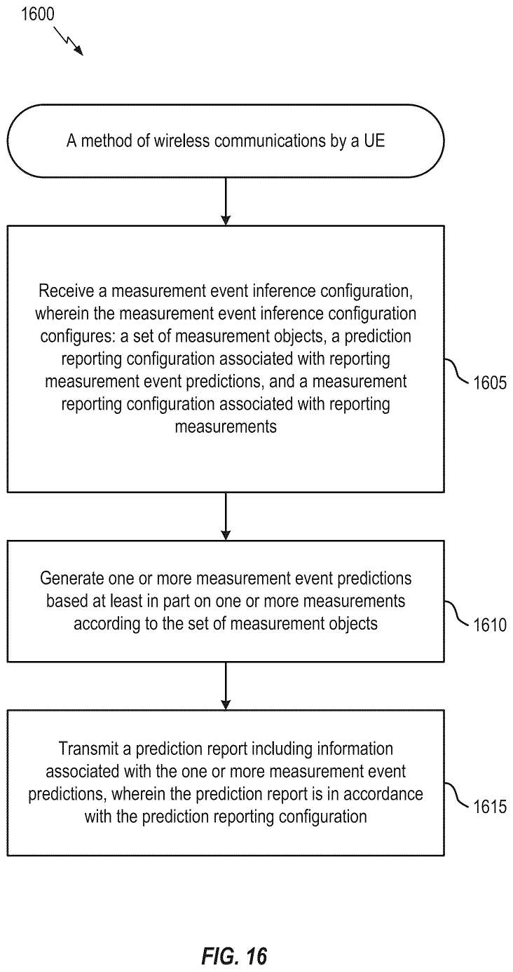

FIG. 16 shows a method 1600 for wireless communications by a UE, such as UE 104 of FIG. 1 or UE 304 of FIG. 3.

Method 1600 begins at block 1605 with receiving a measurement event inference configuration, wherein the measurement event inference configuration configures: a set of measurement objects; a prediction reporting configuration associated with reporting measurement event predictions, and a measurement reporting configuration associated with reporting measurements. For example, the UE 904 may receive a measurement event inference configuration, as depicted and described with respect to reference 906 of FIG. 9.

Method 1600 then proceeds to block 1610 with generating one or more measurement event predictions based at least in part on one or more measurements according to the set of measurement objects. For example, the UE 904 may generate one or more measurement event predictions based at least in part on one or more measurements according to the set of measurement objects, as depicted and described with respect to reference 908 of FIG. 9.

Method 1600 then proceeds to block 1615 with transmitting a prediction report including information associated with the one or more measurement event predictions, wherein the prediction report is in accordance with the prediction reporting configuration. For example, the UE 904 may transmit a prediction report including information associated with the one or more measurement event predictions, as depicted and described with respect to reference 910 of FIG. 9.

In some aspects, method 1600 further includes transmitting a measurement report including information associated with the one or more measurements based at least in part on which the one or more measurement event predictions are generated, wherein the measurement report is in accordance with the measurement reporting configuration. For example, the UE 904 may a measurement report including information associated with the one or more measurements based at least in part on which the one or more measurement event predictions are generated, as depicted and described with respect to reference 912 of FIG. 9.

In some aspects, the set of measurement objects comprises an ARFCN, wherein block 1610 includes: performing the one or more measurements on a first subset of cells or beams in the ARFCN, and generating an intra-frequency measurement event prediction for a second subset of cells or beams in the ARFCN based at least in part on a result of the one or more measurements on the first subset of cells or beams.

In some aspects, method 1600 further includes receiving an indication of a minimum quantity of cells or beams to be measured in association with the intra-frequency measurement event prediction, wherein a quantity of cells or beams in the first subset of cells or beams is in accordance with the indication.

In some aspects, the set of measurement objects comprises a first set of cells or beams in a frequency band and a second set of cells or beams in the frequency band, wherein block 1610 includes: performing the one or more measurements on the first set of cells or beams, and generating an intra-frequency measurement event prediction for the second set of cells or beams based at least in part on a result of the one or more measurements on the first set of cells or beams.

In some aspects, the set of measurement objects comprises a first ARFCN list and a second ARFCN list, wherein block 1610 includes: performing the one or more measurements on a set of cells or beams from the first ARFCN list, and generating an inter-frequency measurement event prediction for a set of cells or beams from the second ARFCN list based at least in part on a result of the one or more measurements on the set of cells or beams from the first ARFCN list.

In some aspects, method 1600 further includes receiving a first indication of a minimum quantity of cells or beams to be measured, receiving a second indication of at least one of: a minimum quantity of cells or beams to be predicted, or a maximum quantity of cells or beams to be predicted, wherein a first quantity of cells or beams in the set of cells or beams from the first ARFCN list is in accordance with the first indication and a second quantity of cells or beams in the set of cells or beams from the second ARFCN list is in accordance with the second indication.

In some aspects, the set of measurement objects comprises a set of cells or beams from a first ARFCN list and a set of cells or beams from a second ARFCN list, wherein block 1610 includes: performing the one or more measurements on the set of cells or beams from the first ARFCN list, and generating an inter-frequency measurement event prediction for the set of cells or beams from the second ARFCN list based at least in part on a result of the one or more measurements on the set of cells or beams from the first ARFCN list.

In some aspects, the one or more measurement event predictions include at least one temporal prediction associated with a plurality of time instances or a time window.

In some aspects, method 1600 further includes detecting a trigger event indicated in the prediction reporting configuration, wherein block 1615 includes transmitting the report based at least in part on the detection of the trigger event.

In some aspects, the prediction reporting configuration indicates a report quantity for the one or more measurement event predictions, wherein the report quantity indicates a single measurement event prediction result or a set of measurement event prediction results associated with a time window.

In some aspects, the prediction reporting configuration and the measurement reporting configuration are included in a single reporting configuration.

In some aspects, the single reporting configuration indicates one or more trigger events, wherein the one or more trigger events include at least one of a UE prediction trigger or a network measurement trigger.

In some aspects, the single reporting configuration indicates reporting contents associated with reporting the one or more measurement event predictions or the one or more measurements.

In some aspects, the prediction reporting configuration and the measurement reporting configuration are separate reporting configurations.

In some aspects, the measurement event inference configuration further includes mapping information that links the prediction reporting configuration and the measurement reporting configuration.

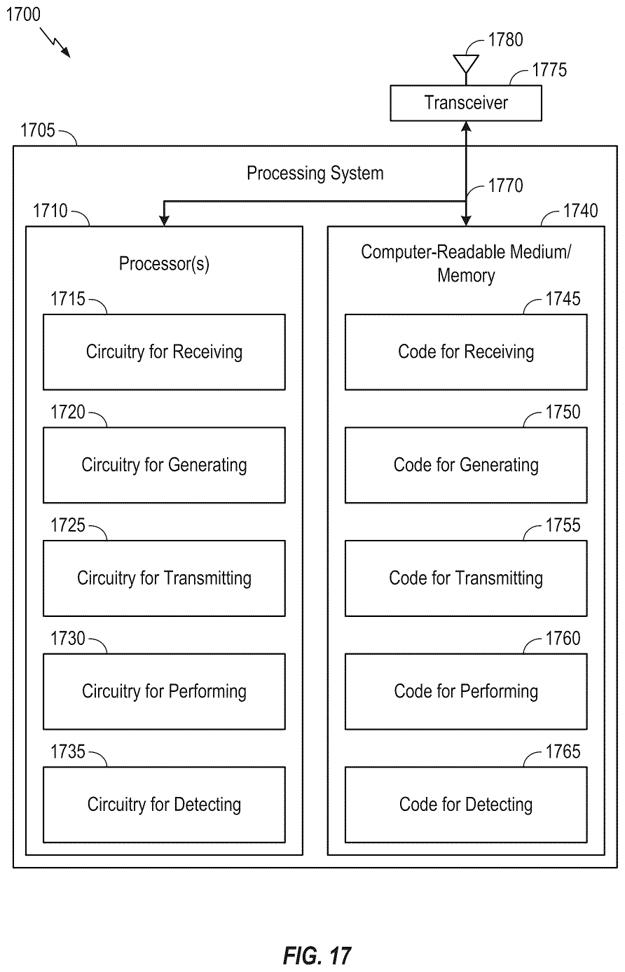

In some aspects, method 1600, or any aspect related to it, may be performed by an apparatus, such as communications device 1700 of FIG. 17, which includes various components operable, configured, or adapted to perform the method 1600. Communications device 1700 is described below in further detail.

In some aspects, the techniques for inference configuration for AI/ML-based mobility depicted and described with respect to the method 1600 may enable improved wireless communications performance, such as such as smooth connectivity, lower latency, or improved quality of service that can be achieved through AI/ML-based mobility. The improved wireless communication performance may be attributable to the method 1600, for example, due to the provisioning of an inference configuration for measurement event prediction performance and reporting that enables AI/ML based mobility.

Note that FIG. 16 is just one example of a method, and other methods including fewer, additional, or alternative operations are possible consistent with this disclosure.

### Example Communications Device

FIG. 17 depicts aspects of an example communications device 1700 configured for wireless communications. In some aspects, communications device 1700 is a user equipment, such as UE 104 described above with respect to FIG. 1 or UE 304 described with respect to FIG. 3.

The communications device 1700 includes a processing system 1705 coupled to a transceiver 1775 (e.g., a transmitter and/or a receiver). The transceiver 1775 is configured to transmit and receive signals for the communications device 1700 via an antenna 1780, such as the various signals as described herein. The processing system 1705 may be configured to perform processing functions for the communications device 1700, including processing signals received and/or to be transmitted by the communications device 1700.

The processing system 1705 includes one or more processors 1710 and a computer-readable medium/memory 1740. In various aspects, the one or more processors 1710 may be representative of the one or more processors 318 described with respect to FIG. 3. The one or more processors 1710 are coupled to a computer-readable medium/memory 1740 via a bus 1770. In some aspects, the computer-readable medium/memory 1740 may be representative of the one or more memories 320 described with respect to FIG. 3. The computer-readable medium/memory 1740 is a non-transitory computer-readable medium/memory. In certain aspects, the computer-readable medium/memory 1740 is configured to store instructions (e.g., computer-executable code), that when executed by the one or more processors 1710, cause the one or more processors 1710 to perform the method 1600 described with respect to FIG. 16, or any aspect related to it, including any operations described in relation to FIG. 16. Note that reference to a processor performing a function of communications device 1700 may include one or more processors performing that function of communications device 1700, such as in a distributed fashion.

In the depicted example, computer-readable medium/memory 1740 stores code (e.g., executable instructions), including code for receiving 1745, code for generating 1750, code for transmitting 1755, code for performing 1760, and code for detecting 1765. Processing of the code 1745-1765 may enable and cause the communications device 1700 to perform the method 1600 described with respect to FIG. 16, or any aspect related to it. For instance, in some aspects, code for receiving 1745 includes code for receiving a measurement event inference configuration, wherein the measurement event inference configuration configures: a set of measurement objects, a prediction reporting configuration associated with reporting measurement event predictions, and a measurement reporting configuration associated with reporting measurements. In some aspects, code for generating 1750 includes code for generating one or more measurement event predictions based at least in part on one or more measurements according to the set of measurement objects. In some aspects, code for transmitting 1755 includes code for transmitting a prediction report including information associated with the one or more measurement event predictions, wherein the prediction report is in accordance with the prediction reporting configuration.

The one or more processors 1710 include circuitry configured to implement (e.g., execute) the code stored in the computer-readable medium/memory 1740, including circuitry for receiving 1715, circuitry for generating 1720, circuitry for transmitting 1725, circuitry for performing 1730, and circuitry for detecting 1735. Processing with circuitry 1715-1735 may enable and cause the communications device 1700 to perform the method 1600 described with respect to FIG. 16, or any aspect related to it. For instance, in some aspects, circuitry for receiving 1715 includes circuitry for receiving a measurement event inference configuration, wherein the measurement event inference configuration configures: a set of measurement objects, a prediction reporting configuration associated with reporting measurement event predictions, and a measurement reporting configuration associated with reporting measurements. In some aspects, circuitry for generating 1720 includes circuitry for generating one or more measurement event predictions based at least in part on one or more measurements according to the set of measurement objects. In some aspects, circuitry for transmitting 1725 includes circuitry for transmitting a prediction report including information associated with the one or more measurement event predictions, wherein the prediction report is in accordance with the prediction reporting configuration.

More generally, means for communicating, transmitting, sending or outputting for transmission may include the one or more transceivers 324, one or more antenna 322 and/or processing system 316 of the UE 304 illustrated in FIG. 3, transceiver 1775 and/or antenna 1780 of the communications device 1700 in FIG. 17, and/or one or more processors 1710 of the communications device 1700 in FIG. 17. Means for communicating, receiving or obtaining may include the one or more transceivers 324, one or more antennas 322, and/or processing system 316 of the UE 304 illustrated in FIG. 3, transceiver 1775 and/or antenna 1780 of the communications device 1700 in FIG. 17, and/or one or more processors 1710 of the communications device 1700 in FIG. 17.

### Example Operations of a Network Entity

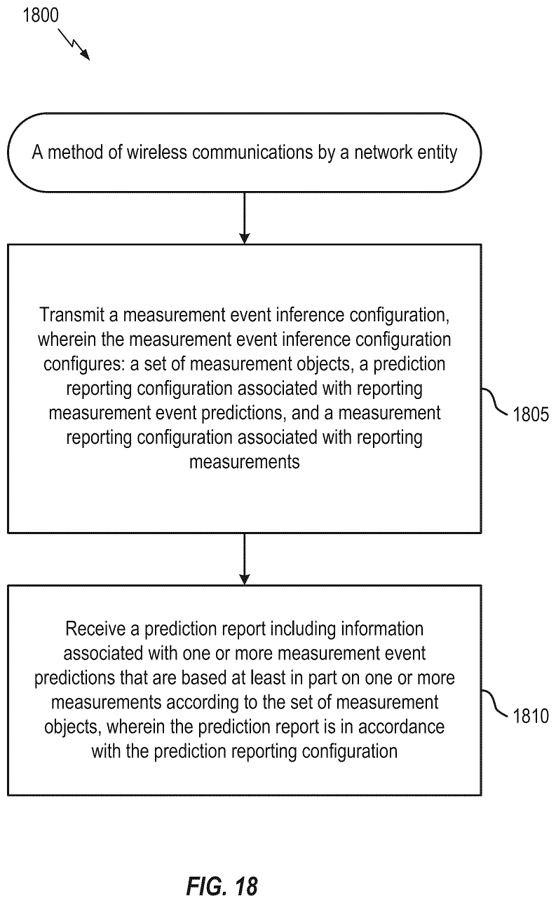

FIG. 18 shows a method 1800 for wireless communications by a network entity, such as BS 102 of FIG. 1, a first network entity 300 or second network entity 302 of FIG. 3, or a disaggregated base station as discussed with respect to FIG. 2.

Method 1800 begins at block 1805 with transmitting a measurement event inference configuration, wherein the measurement event inference configuration configures: a set of measurement objects; a prediction reporting configuration associated with reporting measurement event predictions; and a measurement reporting configuration associated with reporting measurements. For example, the network entity 902 may transmit a measurement event inference configuration, as depicted and described with respect to reference 906 of FIG. 9.

Method 1800 then proceeds to block 1810 with receiving a prediction report including information associated with one or more measurement event predictions that are based at least in part on one or more measurements according to the set of measurement objects, wherein the prediction report is in accordance with the prediction reporting configuration. For example, the network entity 902 may receive a prediction report including information associated with one or more measurement event predictions that are based at least in part on one or more measurements according to the set of measurement objects, as depicted and described with respect to reference 910 of FIG. 9.

In certain aspects, method 1800 further includes receiving a measurement report including information associated with the one or more measurements based at least in part on which the one or more measurement event predictions are generated, wherein the measurement report is in accordance with the measurement reporting configuration. For example, the network entity 902 may receive a measurement report including information associated with the one or more measurements based at least in part on which the one or more measurement event predictions are generated, as depicted and described with respect to reference 912 of FIG. 9.

In some aspects, the set of measurement objects comprises an ARFCN.

In certain aspects, method 1800 further includes transmitting an indication of a minimum quantity of cells or beams of the ARFCN to be measured in association with an intra-frequency measurement event prediction.

In some aspects, the set of measurement objects comprises a first set of cells or beams in a frequency band and a second set of cells or beams in the frequency band.

In some aspects, the set of measurement objects comprises a first ARFCN list and a second ARFCN list.

In certain aspects, method 1800 further includes transmitting a first indication of a minimum quantity of cells or beams of the first ARFCN list to be measured, receiving a second indication of at least one of: a minimum quantity of cells or beams of the second ARFCN list to be predicted, or a maximum quantity of cells or beams of the second ARFCN list to be predicted.

In some aspects, the set of measurement objects comprises a set of cells or beams from a first ARFCN list and a set of cells or beams from a second ARFCN list.

In some aspects, the one or more measurement event predictions include at least one temporal prediction associated with a plurality of time instances or a time window.

In some aspects, the prediction reporting configuration indicates a report quantity for the one or more measurement event predictions, wherein the report quantity indicates a single measurement event prediction result or a set of measurement event prediction results associated with a time window.

In some aspects, the prediction reporting configuration and the measurement reporting configuration are included in a single reporting configuration.

In some aspects, the single reporting configuration indicates one or more trigger events, wherein the one or more trigger events include at least one of a UE prediction trigger or a network measurement trigger.

In some aspects, the single reporting configuration indicates reporting contents associated with reporting the one or more measurement event predictions or the one or more measurements.

In some aspects, the prediction reporting configuration and the measurement reporting configuration are separate reporting configurations.

In some aspects, the measurement event inference configuration further includes mapping information that links the prediction reporting configuration and the measurement reporting configuration.

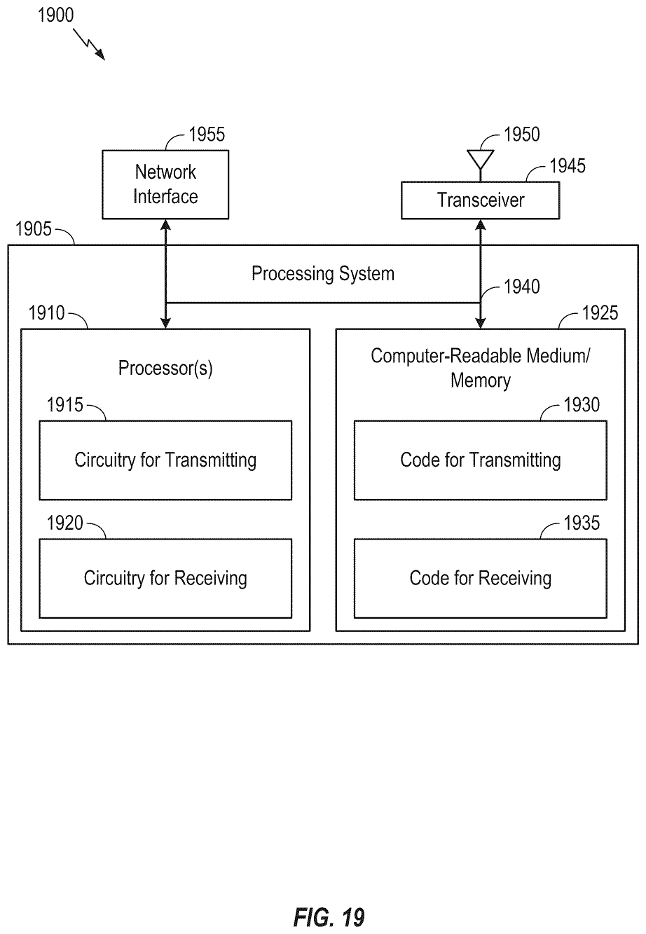

In some aspects, method 1800, or any aspect related to it, may be performed by an apparatus, such as communications device 1900 of FIG. 19, which includes various components operable, configured, or adapted to perform the method 1800. Communications device 1900 is described below in further detail.

In some aspects, the techniques for inference configuration for AI/ML-based mobility depicted and described with respect to the method 1800 may enable improved wireless communications performance, such as such as smooth connectivity, lower latency, or improved quality of service that can be achieved through AI/ML-based mobility. The improved wireless communication performance may be attributable to the method 1800, for example, due to the provisioning of an inference configuration for measurement event prediction performance and reporting that enables AI/ML based mobility.

Note that FIG. 18 is just one example of a method, and other methods including fewer, additional, or alternative operations are possible consistent with this disclosure.

### Example Communications Device

FIG. 19 depicts aspects of an example communications device configured for wireless communications. In some aspects, communications device 1900 is a network entity, such as BS 102 of FIG. 1, first network entity 300 or second network entity 302 of FIG. 3, or a disaggregated base station as discussed with respect to FIG. 2.

The communications device 1900 includes a processing system 1905 coupled to a transceiver 1945 (e.g., a transmitter and/or a receiver) and/or a network interface 1955. The transceiver 1945 is configured to transmit and receive signals for the communications device 1900 via an antenna 1950, such as the various signals as described herein. The network interface 1955 is configured to obtain and send signals for the communications device 1900 via communications link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910 and a computer-readable medium/memory 1925. In various aspects, one or more processors 1910 may be representative of the one or more processors 308, as described with respect to FIG. 3. The one or more processors 1910 are coupled to the computer-readable medium/memory 1925 via a bus 1940. In certain aspects, the computer-readable medium/memory 1925 is configured to store instructions (e.g., computer-executable code), including code 1930 and 1935, that when executed by the one or more processors 1910, cause the one or more processors 1910 to perform the method 1800 described with respect to FIG. 18, or any aspect related to it, including any operations described in relation to FIG. 18. The computer-readable medium/memory 1925 is a non-transitory computer-readable medium/memory. Note that reference to a processor of communications device 1900 performing a function may include one or more processors of communications device 1900 performing that function, such as in a distributed fashion.

In the depicted example, the computer-readable medium/memory 1925 stores code (e.g., executable instructions), including code for transmitting 1930 and code for receiving 1935. Processing of the code 1930 and 1935 may enable and cause the communications device 1900 to perform the method 1800 described with respect to FIG. 18, or any aspect related to it. For instance, in some aspects, code for transmitting 1930 includes code for transmitting a measurement event inference configuration, wherein the measurement event inference configuration configures: a set of measurement objects, a prediction reporting configuration associated with reporting measurement event predictions, and a measurement reporting configuration associated with reporting measurements. In some aspects, code for receiving 1935 includes code for receiving a prediction report including information associated with one or more measurement event predictions that are based at least in part on one or more measurements according to the set of measurement objects, wherein the prediction report is in accordance with the prediction reporting configuration.

The one or more processors 1910 include circuitry configured to implement (e.g., execute) the code stored in the computer-readable medium/memory 1925, including circuitry for transmitting 1915 and circuitry for receiving 1920. Processing with circuitry 1915 and 1920 may enable and cause the communications device 1900 to perform the method 1800 described with respect to FIG. 18, or any aspect related to it. For instance, in some aspects, circuitry for transmitting 1915 includes circuitry for transmitting a measurement event inference configuration, wherein the measurement event inference configuration configures: a set of measurement objects, a prediction reporting configuration associated with reporting measurement event predictions, and a measurement reporting configuration associated with reporting measurements. In some aspects, circuitry for receiving 1920 includes circuitry for receiving a prediction report including information associated with one or more measurement event predictions that are based at least in part on one or more measurements according to the set of measurement objects, wherein the prediction report is in accordance with the prediction reporting configuration.

Various components of the communications device 1900 may provide means for performing the method 1800 described with respect to FIG. 18, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1945, antenna 1950, and/or network interface 1955 of the communications device 1900 in FIG. 19, and/or one or more processors 1910 of the communications device 1900 in FIG. 19. Means for communicating, receiving or obtaining may include the one or more transceivers 312, one or more antennas 314, and/or processing system 306 of the first network entity 300 or the second network entity 302 illustrated in FIG. 3, transceiver 1945, antenna 1950, and/or network interface 1955 of the communications device 1900 in FIG. 19, and/or one or more processors 1910 of the communications device 1900 in FIG. 19.

### Example Clauses

Implementation examples are described in the following numbered clauses:

Clause 1: A method of wireless communications by a UE comprising: receiving an RRM inference configuration, wherein the RRM inference configuration configures: a set of measurement objects, and a reporting configuration; generating one or more RRM predictions based at least in part on one or more measurements according to the set of measurement objects; and transmitting a report including information associated with the one or more RRM predictions, wherein the report is in accordance with the reporting configuration.

Clause 2: The method of Clause 1, wherein the set of measurement objects comprises an ARFCN, wherein generating the one or more RRM predictions comprises: performing the one or more measurements on a first subset of cells or beams in the ARFCN, and generating an intra-frequency RRM prediction for a second subset of cells or beams in the ARFCN based at least in part on a result of the one or more measurements on the first subset of cells or beams.

Clause 3: The method of Clause 2, further comprising: receiving an indication of a minimum quantity of cells or beams to be measured in association with the intra-frequency RRM prediction, wherein a quantity of cells or beams in the first subset of cells or beams is in accordance with the indication.

Clause 4: The method of any one of Clauses 1-3, wherein the set of measurement objects comprises a first set of cells or beams in a frequency band and a second set of cells or beams in the frequency band, wherein generating the one or more RRM predictions comprises: performing the one or more measurements on the first set of cells or beams, and generating an intra-frequency RRM prediction for the second set of cells or beams based at least in part on a result of the one or more measurements on the first set of cells or beams.

Clause 5: The method of any one of Clauses 1-4, wherein the set of measurement objects comprises a first ARFCN list and a second ARFCN list, wherein generating the one or more RRM predictions comprises: performing the one or more measurements on a set of cells or beams from the first ARFCN list, and generating an inter-frequency RRM prediction for a set of cells or beams from the second ARFCN list based at least in part on a result of the one or more measurements on the set of cells or beams from the first ARFCN list.

Clause 6: The method of Clause 5, further comprising: receiving a first indication of a minimum quantity of cells or beams to be measured, receiving a second indication of at least one of: a minimum quantity of cells or beams to be predicted, or a maximum quantity of cells or beams to be predicted, wherein a quantity of cells or beams in the set of cells or beams from the first ARFCN list is in accordance with the first indication and a quantity of cells or beams in the set of cells or beams from the second ARFCN list is in accordance with the second indication.

Clause 7: The method of any one of Clauses 1-6, wherein the set of measurement objects comprises a set of cells or beams from a first ARFCN list and a set of cells or beams from a second ARFCN list, wherein generating the one or more RRM predictions comprises: performing the one or more measurements on the set of cells or beams from the first ARFCN list, and generating an inter-frequency RRM prediction for the set of cells or beams from the second ARFCN list based at least in part on a result of the one or more measurements on the set of cells or beams from the first ARFCN list.

Clause 8: The method of any one of Clauses 1-7, wherein the one or more RRM predictions include at least one spatial prediction.

Clause 9: The method of any one of Clauses 1-8, wherein the one or more RRM predictions include at least one temporal prediction associated with a plurality of time instances or a time window.

Clause 10: The method of any one of Clauses 1-9, further comprising determining that a value of an RRM prediction, of the one or more RRM predictions, satisfies a threshold, wherein transmitting the report comprises transmitting the report including the value of the RRM prediction based at least in part on the value of the RRM prediction satisfying the threshold.

Clause 11: The method of any one of Clauses 1-10, further comprising determining that a value of a result of a measurement associated with a temporal prediction, of the one or more RRM predictions, is within a configured range, wherein transmitting the report comprises dropping the value from the report based at least in part on the value being within the configured range.

Clause 12: The method of any one of Clauses 1-11, wherein the RRM inference configuration configures the set of measurement objects using a single measurement object identifier associated with a single measurement object for measurement and prediction.

Clause 13: The method of any one of Clauses 1-12, wherein the RRM inference configuration configures the set of measurement objects using a first measurement object identifier associated with a first measurement object for measurement, a second measurement object identifier associated with a second measurement object for prediction, and a single measurement identifier associated with both the first measurement object for measurement and the second measurement object for prediction.

Clause 14: The method of any one of Clauses 1-13, wherein the RRM inference configuration configures the set of measurement objects using a first measurement object identifier associated with a first measurement object for measurement, a second measurement object identifier associated with a second measurement object for prediction, a first measurement identifier associated with the first measurement object for measurement, and a second measurement identifier associated with the second measurement object for prediction.

Clause 15: The method of any one of Clauses 1-14, wherein the information associated with the one or more RRM predictions includes one or more actual prediction values.

Clause 16: The method of any one of Clauses 1-15, wherein the information associated with the one or more RRM predictions includes one or more differential values.

Clause 17: The method of Clause 16, wherein a differential value of the one or more differential values is with respect to a single reference value, wherein the single reference value is a highest value among values of measurements of all measurement types.

Clause 18: The method of Clause 16, wherein a differential value of the one or more differential values is with respect to a particular reference value from a set of reference values, wherein the particular reference value is a highest value among values of measurements of a measurement type that matches a measurement type associated with the differential value.

Clause 19: The method of any one of Clauses 1-18, wherein the one or more RRM predictions include a temporal prediction, wherein a reference time associated with the temporal prediction is based on a last measurement occasion associated with the one or more measurements based at least in part on which the temporal prediction is generated.

Clause 20: The method of any one of Clauses 1-19, wherein the one or more RRM predictions include at least one intra-frequency RRM prediction or at least one inter-frequency RRM prediction, wherein the information associated with the one or more RRM predictions includes one or more prediction values.

Clause 21: The method of Clause 20, wherein the one or more prediction values include at least one of: a predicted RSRP, a predicted RSRQ, a predicted SINR, or a predicted beam.

Clause 22: The method of any one of Clauses 1-21, wherein the one or more RRM predictions include at least one intra-frequency RRM prediction or at least one inter-frequency RRM prediction, wherein the information associated with the one or more RRM predictions includes one or more prediction values and one or more measurement values associated with the one or more prediction values.

Clause 23: The method of any one of Clauses 1-22, wherein the one or more RRM predictions include at least one temporal prediction, wherein the information associated with the one or more RRM predictions includes a predicted RSRP over a plurality of time instances or over a time window.

Clause 24: A method of wireless communications by a network entity, comprising: transmitting an RRM inference configuration, wherein the RRM inference configuration configures: a set of measurement objects, and a reporting configuration; and receiving a report including information associated with the one or more RRM predictions based at least in part on one or more measurements according to the set of measurement objects, wherein the report is in accordance with the reporting configuration.

Clause 25: The method of Clause 24, wherein the set of measurement objects comprises an ARFCN.

Clause 26: The method of Clause 25, further comprising: transmitting an indication of a minimum quantity of cells or beams of the ARFCN to be measured in association with an intra-frequency RRM prediction.

Clause 27: The method of any one of Clauses 24-26, wherein the set of measurement objects comprises a first set of cells or beams in a frequency band and a second set of cells or beams in the frequency band.

Clause 28: The method of any one of Clauses 24-27, wherein the set of measurement objects comprises a first ARFCN list and a second ARFCN list.

Clause 29: The method of Clause 28, further comprising: transmitting a first indication of a minimum quantity of cells or beams of the first ARFCN list to be measured, transmitting a second indication of at least one of: a minimum quantity of cells or beams of the second ARFCN list to be predicted, or a maximum quantity of cells or beams of the second ARFCN list to be predicted.

Clause 30: The method of any one of Clauses 24-29, wherein the set of measurement objects comprises a set of cells or beams from a first ARFCN list and a set of cells or beams from a second ARFCN list.

Clause 31: The method of any one of Clauses 24-30, wherein the one or more RRM predictions include at least one spatial prediction.

Clause 32: The method of any one of Clauses 24-31, wherein the one or more RRM predictions include at least one temporal prediction associated with a plurality of time instances or a time window.

Clause 33: The method of any one of Clauses 24-32, wherein the report includes a value of an RRM prediction, of the one or more RRM predictions, based at least in part on the value of the RRM prediction satisfying a threshold.

Clause 34: The method of any one of Clauses 24-33, wherein the RRM inference configuration configures the set of measurement objects using a single measurement object identifier associated with a single measurement object for measurement and prediction.

Clause 35: The method of any one of Clauses 24-34, wherein the RRM inference configuration configures the set of measurement objects using a first measurement object identifier associated with a first measurement object for measurement, a second measurement object identifier associated with a second measurement object for prediction, and a single measurement identifier associated with both the first measurement object for measurement and the second measurement object for prediction.

Clause 36: The method of any one of Clauses 24-35, wherein the RRM inference configuration configures the set of measurement objects using a first measurement object identifier associated with a first measurement object for measurement, a second measurement object identifier associated with a second measurement object for prediction, a first measurement identifier associated with the first measurement object for measurement, and a second measurement identifier associated with the second measurement object for prediction.

Clause 37: The method of any one of Clauses 24-36, wherein the information associated with the one or more RRM predictions includes one or more actual prediction values.

Clause 38: The method of any one of Clauses 24-37, wherein the information associated with the one or more RRM predictions includes one or more differential values.

Clause 39: The method of Clause 38, wherein a differential value of the one or more differential values is with respect to a single reference value, wherein the single reference value is a highest value among values of measurements of all measurement types.

Clause 40: The method of Clause 38, wherein a differential value of the one or more differential values is with respect to a particular reference value from a set of reference values, wherein the particular reference value is a highest value among values of measurements of a measurement type that matches a measurement type associated with the differential value.

Clause 41: The method of any one of Clauses 24-40, wherein the one or more RRM predictions include a temporal prediction, wherein a reference time associated with the temporal prediction is based on a last measurement occasion associated with the one or more measurements based at least in part on which the temporal prediction is generated.

Clause 42: The method of any one of Clauses 24-41, wherein the one or more RRM predictions include at least one intra-frequency RRM prediction or at least one inter-frequency RRM prediction, wherein the information associated with the one or more RRM predictions includes one or more prediction values.

Clause 43: The method of Clause 42, wherein the one or more prediction values include at least one of: a predicted RSRP, a predicted RSRQ, a predicted SINR, or a predicted beam.

Clause 44: The method of any one of Clauses 24-43, wherein the one or more RRM predictions include at least one intra-frequency RRM prediction or at least one inter-frequency RRM prediction, wherein the information associated with the one or more RRM predictions includes one or more prediction values and one or more measurement values associated with the one or more prediction values.

Clause 45: The method of any one of Clauses 24-44, wherein the one or more RRM predictions include at least one temporal prediction, wherein the information associated with the one or more RRM predictions includes a predicted RSRP over a plurality of time instances or over a time window.

Clause 46: A method of wireless communications by a UE, comprising: receiving a measurement event inference configuration, wherein the measurement event inference configuration configures: a set of measurement objects, a prediction reporting configuration associated with reporting measurement event predictions; and a measurement reporting configuration associated with reporting measurements; generating one or more measurement event predictions based at least in part on one or more measurements according to the set of measurement objects; and transmitting a prediction report including information associated with the one or more measurement event predictions, wherein the prediction report is in accordance with the prediction reporting configuration.

Clause 47: The method of Clause 46, further comprising transmitting a measurement report including information associated with the one or more measurements based at least in part on which the one or more measurement event predictions are generated, wherein the measurement report is in accordance with the measurement reporting configuration.

Clause 48: The method of any one of Clauses 46-47, wherein the set of measurement objects comprises an ARFCN, wherein generating the one or more measurement event predictions comprises: performing the one or more measurements on a first subset of cells or beams in the ARFCN, and generating an intra-frequency measurement event prediction for a second subset of cells or beams in the ARFCN based at least in part on a result of the one or more measurements on the first subset of cells or beams.

Clause 49: The method of Clause 48, further comprising: receiving an indication of a minimum quantity of cells or beams to be measured in association with the intra-frequency measurement event prediction, wherein a quantity of cells or beams in the first subset of cells or beams is in accordance with the indication.

Clause 50: The method of any one of Clauses 46-49, wherein the set of measurement objects comprises a first set of cells or beams in a frequency band and a second set of cells or beams in the frequency band, wherein generating the one or more measurement event predictions comprises: performing the one or more measurements on the first set of cells or beams, and generating an intra-frequency measurement event prediction for the second set of cells or beams based at least in part on a result of the one or more measurements on the first set of cells or beams.

Clause 51: The method of any one of Clauses 46-50, wherein the set of measurement objects comprises a first ARFCN list and a second ARFCN list, wherein generating the one or more measurement event predictions comprises: performing the one or more measurements on a set of cells or beams from the first ARFCN list, and generating an inter-frequency measurement event prediction for a set of cells or beams from the second ARFCN list based at least in part on a result of the one or more measurements on the set of cells or beams from the first ARFCN list.

Clause 52: The method of Clause 51, further comprising: receiving a first indication of a minimum quantity of cells or beams to be measured, receiving a second indication of at least one of: a minimum quantity of cells or beams to be predicted, or a maximum quantity of cells or beams to be predicted, wherein a first quantity of cells or beams in the set of cells or beams from the first ARFCN list is in accordance with the first indication and a second quantity of cells or beams in the set of cells or beams from the second ARFCN list is in accordance with the second indication.

Clause 53: The method of any one of Clauses 46-52, wherein the set of measurement objects comprises a set of cells or beams from a first ARFCN list and a set of cells or beams from a second ARFCN list, wherein generating the one or more measurement event predictions comprises: performing the one or more measurements on the set of cells or beams from the first ARFCN list, and generating an inter-frequency measurement event prediction for the set of cells or beams from the second ARFCN list based at least in part on a result of the one or more measurements on the set of cells or beams from the first ARFCN list.

Clause 54: The method of any one of Clauses 46-53, wherein the one or more measurement event predictions include at least one temporal prediction associated with a plurality of time instances or a time window.

Clause 55: The method of any one of Clauses 46-54, further comprising: detecting a trigger event indicated in the prediction reporting configuration, wherein transmitting the report comprises transmitting the report based at least in part on the detection of the trigger event.

Clause 56: The method of any one of Clauses 46-55, wherein the prediction reporting configuration indicates a report quantity for the one or more measurement event predictions, wherein the report quantity indicates a single measurement event prediction result or a set of measurement event prediction results associated with a time window.

Clause 57: The method of any one of Clauses 46-56, wherein the prediction reporting configuration and the measurement reporting configuration are included in a single reporting configuration.

Clause 58: The method of Clause 57, wherein the single reporting configuration indicates one or more trigger events, wherein the one or more trigger events include at least one of a UE prediction trigger or a network measurement trigger.

Clause 59: The method of Clause 57, wherein the single reporting configuration indicates reporting contents associated with reporting the one or more measurement event predictions or the one or more measurements.

Clause 60: The method of any one of Clauses 46-59, wherein the prediction reporting configuration and the measurement reporting configuration are separate reporting configurations.

Clause 61: The method of Clause 60, wherein the measurement event inference configuration further includes mapping information that links the prediction reporting configuration and the measurement reporting configuration.

Clause 62: A method of wireless communications by a network entity, comprising: transmitting a measurement event inference configuration, wherein the measurement event inference configuration configures: a set of measurement objects, a prediction reporting configuration associated with reporting measurement event predictions; and a measurement reporting configuration associated with reporting measurements; and receiving a prediction report including information associated with one or more measurement event predictions that are based at least in part on one or more measurements according to the set of measurement objects, wherein the prediction report is in accordance with the prediction reporting configuration.

Clause 63: The method of Clause 62, further comprising receiving a measurement report including information associated with the one or more measurements based at least in part on which the one or more measurement event predictions are generated, wherein the measurement report is in accordance with the measurement reporting configuration.

Clause 64: The method of any one of Clauses 62-63, wherein the set of measurement objects comprises an ARFCN.

Clause 65: The method of Clause 64, further comprising: transmitting an indication of a minimum quantity of cells or beams of the ARFCN to be measured in association with an intra-frequency measurement event prediction.

Clause 66: The method of any one of Clauses 62-65, wherein the set of measurement objects comprises a first set of cells or beams in a frequency band and a second set of cells or beams in the frequency band.

Clause 67: The method of any one of Clauses 62-66, wherein the set of measurement objects comprises a first ARFCN list and a second ARFCN list.

Clause 68: The method of Clause 67, further comprising: transmitting a first indication of a minimum quantity of cells or beams of the first ARFCN list to be measured, receiving a second indication of at least one of: a minimum quantity of cells or beams of the second ARFCN list to be predicted, or a maximum quantity of cells or beams of the second ARFCN list to be predicted.

Clause 69: The method of any one of Clauses 62-68, wherein the set of measurement objects comprises a set of cells or beams from a first ARFCN list and a set of cells or beams from a second ARFCN list.

Clause 70: The method of any one of Clauses 62-69, wherein the one or more measurement event predictions include at least one temporal prediction associated with a plurality of time instances or a time window.

Clause 71: The method of any one of Clauses 62-70, wherein the prediction reporting configuration indicates a report quantity for the one or more measurement event predictions, wherein the report quantity indicates a single measurement event prediction result or a set of measurement event prediction results associated with a time window.

Clause 72: The method of any one of Clauses 62-71, wherein the prediction reporting configuration and the measurement reporting configuration are included in a single reporting configuration.

Clause 73: The method of Clause 72, wherein the single reporting configuration indicates one or more trigger events, wherein the one or more trigger events include at least one of a UE prediction trigger or a network measurement trigger.

Clause 74: The method of Clause 72, wherein the single reporting configuration indicates reporting contents associated with reporting the one or more measurement event predictions or the one or more measurements.

Clause 75: The method of any one of Clauses 62-74, wherein the prediction reporting configuration and the measurement reporting configuration are separate reporting configurations.

Clause 76: The method of Clause 75, wherein the measurement event inference configuration further includes mapping information that links the prediction reporting configuration and the measurement reporting configuration.

Clause 77: One or more apparatuses, comprising: one or more memories comprising executable instructions; and one or more processors configured to execute the executable instructions and cause the one or more apparatuses to perform a method in accordance with any one of Clauses 1-76.

Clause 78: One or more apparatuses configured for wireless communications, comprising: one or more memories; and one or more processors, coupled to the one or more memories, configured to cause the one or more apparatuses to perform a method in accordance with any one of Clauses 1-76.

Clause 79: One or more apparatuses configured for wireless communications, comprising: one or more memories; and one or more processors, coupled to the one or more memories, configured to perform a method in accordance with any one of Clauses 1-76.

Clause 80: One or more apparatuses, comprising means for performing a method in accordance with any one of Clauses 1-76.

Clause 81: One or more non-transitory computer-readable media comprising executable instructions that, when executed by one or more processors of one or more apparatuses, cause the one or more apparatuses to perform a method in accordance with any one of Clauses 1-76.

Clause 82: One or more computer program products embodied on one or more computer-readable storage media comprising code for performing a method in accordance with any one of Clauses 1-76.

Clause 83: One or more apparatuses configured for wireless communications, comprising: a processing system that includes one or more processors and one or more memories coupled with the one or more processors, the processing system configured to cause the one or more apparatuses to perform a method in accordance with any one of Clauses 1-76.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communication, comprising a processing system that includes one or more processors and one or more memories coupled with the one or more processors, the processing system configured to cause a user equipment (UE) to:
receive a radio resource management (RRM) inference configuration, wherein the RRM inference configuration configures:
a set of measurement objects; and
a reporting configuration;
generate one or more RRM predictions based at least in part on one or more measurements according to the set of measurement objects; and
transmit a report including information associated with the one or more RRM predictions,
wherein the report is in accordance with the reporting configuration.

2. The apparatus of claim 1, wherein the set of measurement objects comprises an absolute radio frequency channel number (ARFCN), wherein to cause the UE to generate the one or more RRM predictions, the processing system is configured to cause the UE to:
perform the one or more measurements on a first subset of cells or beams in the ARFCN, and
generate an intra-frequency RRM prediction for a second subset of cells or beams in the ARFCN based at least in part on a result of the one or more measurements on the first subset of cells or beams.

3. The apparatus of claim 1, wherein the set of measurement objects comprises a first set of cells or beams in a frequency band and a second set of cells or beams in the frequency band, wherein to cause the UE to generate the one or more RRM predictions, the processing system is configured to cause the UE to:
perform the one or more measurements on the first set of cells or beams, and
generate an intra-frequency RRM prediction for the second set of cells or beams based at least in part on a result of the one or more measurements on the first set of cells or beams.

4. The apparatus of claim 1, wherein the set of measurement objects comprises a first absolute radio frequency channel number (ARFCN) list and a second ARFCN list, wherein to cause the UE to generate the one or more RRM predictions, the processing system is configured to cause the UE to:
perform the one or more measurements on a set of cells or beams from the first ARFCN list, and
generate an inter-frequency RRM prediction for a set of cells or beams from the second ARFCN list based at least in part on a result of the one or more measurements on the set of cells or beams from the first ARFCN list.

5. The apparatus of claim 1, wherein the set of measurement objects comprises a set of cells or beams from a first absolute radio frequency channel number (ARFCN) list and a set of cells or beams from a second ARFCN list, wherein to cause the UE to generate the one or more RRM predictions, the processing system is configured to cause the UE to:
perform the one or more measurements on the set of cells or beams from the first ARFCN list, and
generate an inter-frequency RRM prediction for the set of cells or beams from the second ARFCN list based at least in part on a result of the one or more measurements on the set of cells or beams from the first ARFCN list.

6. The apparatus of claim 1, wherein the one or more RRM predictions include at least one spatial prediction.

7. The apparatus of claim 1, wherein the one or more RRM predictions include at least one temporal prediction associated with a plurality of time instances or a time window.

8. The apparatus of claim 1, wherein the processing system is further configured to cause the UE to determine that a value of an RRM prediction, of the one or more RRM predictions, satisfies a threshold,
wherein to cause the UE to transmit the report, the processing system is configured to cause the UE to transmit the report including the value of the RRM prediction based at least in part on the value of the RRM prediction satisfying the threshold.

9. The apparatus of claim 1, wherein the processing system is further configured to cause the UE to determine that a value of a result of a measurement associated with a temporal prediction, of the one or more RRM predictions, is within a configured range,
wherein to cause the UE to transmit the report, the processing system is configured to cause the UE to drop the value from the report based at least in part on the value being within the configured range.

10. The apparatus of claim 1, wherein the RRM inference configuration configures the set of measurement objects using a single measurement object identifier associated with a single measurement object for measurement and prediction.

11. The apparatus of claim 1, wherein the RRM inference configuration configures the set of measurement objects using a first measurement object identifier associated with a first measurement object for measurement, a second measurement object identifier associated with a second measurement object for prediction, and a single measurement identifier associated with both the first measurement object for measurement and the second measurement object for prediction.

12. The apparatus of claim 1, wherein the RRM inference configuration configures the set of measurement objects using a first measurement object identifier associated with a first measurement object for measurement, a second measurement object identifier associated with a second measurement object for prediction, a first measurement identifier associated with the first measurement object for measurement, and a second measurement identifier associated with the second measurement object for prediction.

13. The apparatus of claim 1, wherein the information associated with the one or more RRM predictions includes one or more actual prediction values.

14. The apparatus of claim 1, wherein the information associated with the one or more RRM predictions includes one or more differential values.

15. The apparatus of claim 1, wherein the one or more RRM predictions include a temporal prediction, wherein a reference time associated with the temporal prediction is based on a last measurement occasion associated with the one or more measurements based at least in part on which the temporal prediction is generated.

16. The apparatus of claim 1, wherein the one or more RRM predictions include at least one intra-frequency RRM prediction or at least one inter-frequency RRM prediction, wherein the information associated with the one or more RRM predictions includes one or more prediction values.

17. The apparatus of claim 1, wherein the one or more RRM predictions include at least one intra-frequency RRM prediction or at least one inter-frequency RRM prediction, wherein the information associated with the one or more RRM predictions includes one or more prediction values and one or more measurement values associated with the one or more prediction values.

18. The apparatus of claim 1, wherein the one or more RRM predictions include at least one temporal prediction, wherein the information associated with the one or more RRM predictions includes a predicted reference signal received power (RSRP) over a plurality of time instances or over a time window.

19. An apparatus configured for wireless communication, comprising a processing system that includes one or more processors and one or more memories coupled with the one or more processors, the processing system configured to cause a network entity to:
transmit a radio resource management (RRM) inference configuration, wherein the RRM inference configuration configures:
a set of measurement objects; and
a reporting configuration; and
receive a report including information associated with the one or more RRM predictions based at least in part on one or more measurements according to the set of measurement objects,
wherein the report is in accordance with the reporting configuration.

20. An apparatus configured for wireless communication, comprising a processing system that includes one or more processors and one or more memories coupled with the one or more processors, the processing system configured to cause a user equipment (UE) to:
receive a measurement event inference configuration, wherein the measurement event inference configuration configures:
a set of measurement objects;
a prediction reporting configuration associated with reporting measurement event predictions; and
a measurement reporting configuration associated with reporting measurements;
generate one or more measurement event predictions based at least in part on one or more measurements according to the set of measurement objects; and
transmit a prediction report including information associated with the one or more measurement event predictions,
wherein the prediction report is in accordance with the prediction reporting configuration.
